(19) United States
(12) Patent Application Publication
(10) Pub. No.: US 2026/0104805 A1
(43) Pub. Date: Apr. 16, 2026

(54) DATA STORAGE DEVICE SUPPORTING DATA RECOVERY READ OPERATION AND OPERATION METHOD THEREOF

(71) Applicant: Samsung Electronics Co., Ltd., Suwon-si (KR)

(72) Inventors: Sangsoo Park, Suwon-si (KR); Se Hwan Park, Suwon-si (KR); Jin-Young Kim, Suwon-si (KR); Eunhyang Park, Suwon-si (KR)

(21) Appl. No.: 19/336,415

(22) Filed: Sep. 22, 2025

(30) Foreign Application Priority Data
Oct. 15, 2024 (KR) 10-2024-0140591

(51) Int. Cl. G06F 3/06

(52) U.S. Cl. CPC G06F 3/0619; G06F 3/0659; G06F 3/0679

(57) ABSTRACT

An example data recovery operation method includes classifying memory cells connected with a victim wordline into a plurality of victim groups, based on information of an aggressor wordline adjacent to the victim wordline from among a plurality of wordlines, performing a cell count operation for a first area of a first victim group among the plurality of victim groups and a cell count operation for a second area of a second victim group among the plurality of victim groups, respectively, determining a data recovery read voltage level, based on a first count value of the first area and a second count value of the second area, and performing a data recovery read operation for the victim wordline, based on the data recovery read voltage level.

### CROSS-REFERENCE TO RELATED APPLICATION

This application claims priority under 35 U.S.C. § 119 to Korean Patent Application No. 10-2024-0140591 filed on Oct. 15, 2024, in the Korean Intellectual Property Office, the disclosure of which is incorporated by reference herein in its entirety.

### BACKGROUND

A semiconductor memory device may be classified as a volatile memory device or a nonvolatile memory device. The volatile memory device is fast in read and write speeds but loses data stored therein when power is turned off. In contrast, when power is turned off, the nonvolatile memory device retains information stored therein. Therefore, the nonvolatile memory device is used to store information that has to be retained regardless of whether power is supplied.

A flash memory device may be a representative example of the nonvolatile memory device. The flash memory device is used as a medium for storing audio and image data of information devices such as a computer, a mobile phone, a smartphone, a personal digital assistant (PDA), a digital camera, a camcorder, a voice recorder, an MP3 player, a handheld PC, a game console, a facsimile, a scanner, and a printer.

As the number of information devices using the nonvolatile memory device as a storage device increases, the capacity of the nonvolatile memory device increases, and demand for a data recovery read operation increases.

### SUMMARY

Implementations of the present disclosure relates to a memory device capable of performing an optimal data recovery read operation in various deterioration situations and a storage system including the same.

### BRIEF DESCRIPTION OF THE DRAWINGS

The above and other objects and features of the present disclosure will become apparent by describing in detail implementations thereof with reference to the accompanying drawings.

FIG. 1 is a block diagram illustrating an example of a data storage device.

FIG. 2 is a block diagram illustrating an example of a memory device.

FIG. 3 is a circuit diagram illustrating an example memory block among a plurality of memory blocks.

FIG. 4 is a flowchart for describing an example of a data recovery read operation.

FIG. 5 is a flowchart for describing an example in which memory cells of a victim wordline are classified into a plurality of victim groups.

FIGS. 6, 7, and 8 are diagrams for describing an example in which memory cells of a victim wordline are classified into a plurality of victim groups based on a read operation for an aggressor group, in detail.

FIGS. 9, 10, and 11 are diagrams for describing an example in which memory cells of a victim wordline are classified into a plurality of victim groups based on a read operation for an aggressor group, in detail.

FIG. 12 is a flowchart for describing an example of a cell count operation for at least two victim groups.

FIG. 13 is a diagram illustrating an example of a first area of a first victim group and a second area of a second victim group, in which a cell count operation is performed.

FIG. 14 is an example flowchart for describing how to determine a read voltage level for a data recovery read operation based on count values of at least two victim groups.

FIG. 15 is a diagram illustrating an example in which a type of deterioration is checked depending on a comparison result of count values of at least two victim groups.

FIG. 16 is an example flowchart for determining a read voltage level for a data recovery read operation depending on a deterioration situation by applying different offset tables.

FIG. 17A is a diagram illustrating an example of a first offset table applied in a deterioration situation where lateral spreading is relatively great.

FIG. 17B is a diagram illustrating an example in which a read voltage level for a data recovery read operation is determined by applying a first offset table.

FIG. 18A is a diagram illustrating an example of a second offset table applied in a deterioration situation where lateral spreading is relatively small.

FIG. 18B is a diagram illustrating an example in which a read voltage level for a data recovery read operation is determined by using a second offset table.

FIG. 19 is an example flowchart for determining a read voltage level for a data recovery read operation by compensating for an offset voltage by using different values depending on deterioration situations, with the same offset table applied.

FIG. 20A is a diagram illustrating an example of a common offset table identically applied regardless of the degree of lateral spreading deterioration.

FIG. 20B is a diagram illustrating an example of compensating for an offset voltage to be applied to the deterioration that lateral spreading is relatively great.

FIG. 20C is a diagram illustrating an example of compensating for an offset voltage to be applied to the deterioration that lateral spreading is relatively small.

FIG. 21 is a block diagram schematically illustrating an example of a page buffer.

FIG. 22 is a diagram illustrating an example of a cell count operation for a first area of a first victim group and a second area of a second victim group.

FIGS. 23, 24A, 24B, and 24C are diagrams for describing an example of an operation of counting the number of memory cells located in an area between a second threshold voltage and a third threshold voltage of a second state in detail.

FIGS. 25 and 26 are diagrams for describing an example of an operation of obtaining a count value of a second area of a second sub-state by masking memory cells corresponding to a first sub-state from among memory cells located in a third area of a second state.

FIG. 27 is an example flowchart for performing a cell count operation for a first area of a first victim group and a cell count operation for a second area of a second victim group.

FIG. 28 is a diagram illustrating an example of a cell count operation for a first area of a first victim group and a second area of a second victim group.

FIG. 29 is an example flowchart for performing a cell count operation for a first area of a first victim group and a cell count operation for a second area of a second victim group.

FIG. 30 is a diagram illustrating an example of a cell count operation for a first area of a first victim group and a second area of a second victim group.

FIG. 31 is a block diagram illustrating an example of a data storage device.

### DETAILED DESCRIPTION

Below, implementations of the present disclosure will be described in detail and clearly to such an extent that an ordinary one in the art easily carries out the present disclosure.

### Data Storage Device Setting Read Voltage Level of Data Recovery Read Operation Based on Count Value for Victim Group

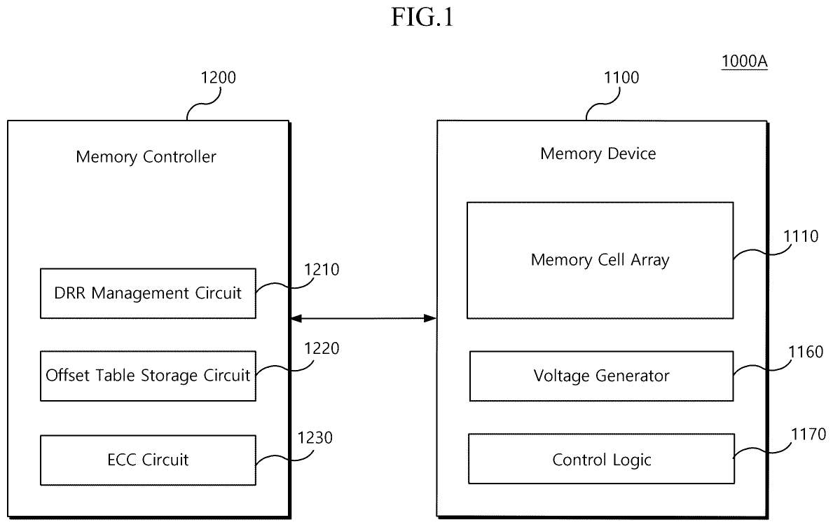

FIG. 1 is a block diagram illustrating an example of a data storage device 1000A.

The data storage device 1000A may support a data recovery read operation. In particular, the data storage device 1000A may classify memory cells connected to a selected wordline among a plurality of wordlines into a plurality of victim groups, based on threshold voltages of memory cells connected to a wordline adjacent to the selected wordline. The data storage device 1000A may determine a read voltage level for a data recovery read operation, based on a count value of memory cells corresponding to a first area of a first victim group among the plurality of victim groups and a count value of memory cells corresponding to a second area of a second victim group among the plurality of victim groups. Accordingly, an optimal data recovery read operation may be performed in various deterioration situations.

Referring to FIG. 1, the data storage device 1000A may include a memory device 1100 and a memory controller 1200.

The memory device 1100 may receive an address signal, a write command signal, and user data from the memory controller 1200. The memory device 1100 may store the user data, based on the address signal and the write command signal. Alternatively, the memory device 1100 may receive an address signal and a read command signal from the memory controller 1200. The memory device 1100 may read the user data, based on the address signal and the read command signal and may provide the read user data to the memory controller 1200.

The memory device 1100 may include a memory cell array 1110, a voltage generator 1160, and control logic 1170.

The memory cell array 1110 may include a plurality of memory blocks which store data. For example, the plurality of memory blocks may be implemented to include flash memory cells. However, this is provided as an example, and the present disclosure is not limited thereto. Below, it is assumed that a memory block of the memory cell array 1110 is a memory block including flash memory cells.

Each memory block may include a plurality of memory cells disposed at intersections of a plurality of wordlines and a plurality of bitlines. The plurality of memory cells may form a plurality of threshold voltage distributions depending on programmed data.

For example, when a memory cell is a single level cell (hereinafter referred to as an “SLC”) storing one bit, the memory cells may form two threshold voltage distributions depending on program states. As another example, when a memory cell is a multi-level cell (hereinafter referred to as an “MLC”) storing two bits, the memory cells may form four threshold voltage distributions depending on program states. As another example, when a memory cell is a triple level cell (hereinafter referred to as a “TLC”) storing three bits, the memory cells may form eight threshold voltage distributions depending on program states. As another example, when a memory cell store 4 or more bits, the memory cells may form sixteen threshold voltage distributions depending on program states.

In some implementations, a state of each threshold voltage distribution of a selected wordline among a plurality of wordlines may be classified into at least two sub-states. For example, the state of each threshold voltage distribution of the selected wordline may be divided into a first sub-state corresponding to memory cells belonging to a first group and a second sub-state corresponding to memory cells belonging to a second group.

In this case, the memory cells connected to the selected wordline may be classified into a plurality of groups, based on group information of an adjacent wordline among the plurality of wordlines. Below, for convenience of description, a selected wordline may be referred to as a “victim wordline”, and a group corresponding to the victim wordline may be referred to as a “victim group”. Also, an adjacent wordline may be referred to as an “aggressor wordline”, and a group corresponding to the aggressor wordline may be referred to as an “aggressor group”.

The voltage generator 1160 may generate wordline voltages and may apply the wordline voltages to the plurality of wordlines. For example, the voltage generator 1160 may generate wordline voltages to be used in the data recovery read operation.

The control logic 1170 may allow the voltage generator 1160 to generate the wordline voltages. For example, the control logic 1170 may allow the voltage generator 1160 to generate the wordline voltages to be used in the data recovery read operation. Also, the control logic 1170 may control all the operations of the memory device 1100.

The memory controller 1200 may control the memory device 1100 such that data are read from the memory device 1100 or data are programmed in memory device 1100. For example, the memory controller 1200 may control the program operation, the read operation, and the erase operation for the memory device 1100 by providing a command, an address, and/or a control signal to the memory device 1100.

The memory controller 1200 may communicate with a host through various standard interfaces. For example, the memory controller 1200 may communicate with the host through various schemes of interfaces such as an advanced technology attachment (ATA) interface, a serial ATA (SATA) interface, an external SATA (e-SATA) interface, a small computer small interface (SCSI), a serial attached SCSI (SAS) interface, a peripheral component interconnection (PCI) interface, a PCI express (PCI-E) interface, an IEEE 1394 interface, a universal serial bus (USB) interface, a secure digital (SD) card interface, a multimedia card (MMC) interface, an embedded multimedia card (eMMC) interface, a universal flash storage (UFS) interface, and a compact flash (CF) card interface.

The memory controller 1200 may allow the memory device 1100 to perform the data recovery read operation. In particular, the memory controller 1200 may determine an optimal offset voltage depending on a deterioration situation such that the optimal data recovery read operation is performed in various deterioration situations. To this end, the memory controller 1200 may include a data recovery read management circuit (hereinafter referred to as a “DDR management circuit”) 1210, an offset table storage circuit 1220, and an ECC circuit 1230.

The DRR management circuit 1210 may control a read voltage to be used in the data recovery read operation. For example, when data read from the memory device 1100 are not corrected by the ECC circuit 1230, the DRR management circuit 1210 may enter a data recovery read operation mode.

In the data recovery read operation mode, the DRR management circuit 1210 may determine an optimal offset voltage depending on various deterioration situations of the victim wordline. For example, the DRR management circuit 1210 may divide each state of a threshold voltage distribution of the victim wordline into at least two sub-states. The DRR management circuit 1210 may determine the optimal offset voltage, based on a result of comparing count values for the at least two sub-states. The offset voltage may be applied to a normal read voltage, and thus, a voltage level for the data recovery read operation may be determined.

In detail, in some implementations, the DRR management circuit 1210 may classify memory cells connected to the aggressor wordline into a plurality of aggressor groups. For example, the DRR management circuit 1210 may classify the memory cells connected to the aggressor wordline into at least two aggressor groups, based on a threshold voltage of each of the memory cells connected to the aggressor wordline.

Also, in some implementations, the DRR management circuit 1210 may classify the memory cells connected to the victim wordline into a plurality of victim groups, based on aggressor group information of each of the memory cells connected to the aggressor wordline. For example, a memory cell of the victim wordline corresponding to a memory cell belonging to a first aggressor group may be classified as a first victim group, and a memory cell of the victim wordline corresponding to a memory cell belonging to a second aggressor group may be classified as a second victim group.

Also, in some implementations, the DRR management circuit 1210 may divide the state of each threshold voltage distribution of the victim wordline into at least two sub-states, based on group information of the victim wordline. For example, when the memory cells connected to the victim wordline are classified into two victim groups, the DRR management circuit 1210 may divide the state of each threshold voltage distribution of the victim wordline into a first sub-state and a second sub-state. Herein, the first sub-state may be formed of the memory cells belonging to the first victim group, and the second sub-state may be formed of memory cells belonging to the second victim group.

Also, in some implementations, the DRR management circuit 1210 may determine the optimal offset voltage to be applied to the data recovery read operation, based on a result of comparing a count value of memory cells corresponding to a first area of the first victim group among the plurality of victim groups and a count value of memory cells corresponding to a second area of the second victim group among the plurality of victim groups. According to the above description, the optimal read voltage level for the data recovery read operation may be determined.

In some implementations, the number of memory cells corresponding to the first area of the first victim group and the number of memory cells corresponding to the second area of the second victim group are equal or are less than a reference number, the DRR management circuit 1210 may determine that the proportion of lateral spreading in the deterioration of the threshold voltage distribution of the victim wordline is relatively great.

For example, when the deterioration is made at a high temperature, the proportion of lateral spreading in the deterioration may be relatively great. In this case, the DRR management circuit 1210 may select a relatively great offset voltage to compensate for the deterioration of relatively great lateral spreading. Afterwards, the read voltage level for the data recovery read operation may be determined by using the selected offset voltage.

In some implementations, the number of memory cells corresponding to the first area of the first victim group and the number of memory cells corresponding to the second area of the second victim group are more than the reference number, the DRR management circuit 1210 may determine that the proportion of lateral spreading in the deterioration of the threshold voltage distribution of the victim wordline is relatively small.

For example, when the deterioration is made at a low temperature, the proportion of lateral spreading in the deterioration may be relatively small. In this case, the DRR management circuit 1210 may select a relatively small offset voltage to compensate for the deterioration of relatively small lateral spreading. Afterwards, the read voltage level for the data recovery read operation may be determined by using the selected offset voltage.

The offset table storage circuit 1220 may store an offset voltage to be applied to the data recovery read operation. For example, the offset table storage circuit 1220 may store offset tables, and offset voltages to be applied to the data recovery read operation may be managed in each offset table.

In some implementations, the offset table storage circuit 1220 may include a plurality of offset tables, and an offset table may be differently applied depending on a deterioration situation.

For example, the offset table storage circuit 1220 may include a first offset table to be applied in a deterioration situation where lateral spreading is relatively great and a second offset table to be applied in a deterioration situation where lateral spreading is relatively small. In this case, magnitudes of offset voltage values which are managed in the first offset table may be relatively greater than magnitudes of offset voltage values which are managed in the second offset table.

In some implementations, the offset table storage circuit 1220 may include a common offset table to be applied in common to different deterioration situations. In this case, the DRR management circuit 1210 may compensate for an offset voltage level, which is managed in the common offset table, by using different values depending on deterioration situations.

For example, in the case of a deterioration situation where lateral spreading is relatively great, the DRR management circuit 1210 may compensate for the offset voltage level, which is managed in the common offset table, by using a relatively great voltage value. As another example, in the case of a deterioration situation where lateral spreading is relatively small, the DRR management circuit 1210 may compensate for the offset voltage level, which is managed in the common offset table, by using a relatively small voltage value.

The ECC circuit 1230 may detect an error of data read from the memory device 1100 and may correct the detected error. For example, the ECC circuit 1230 may generate an error correction code for data to be stored in the memory device 1100. The generated error correction code may be stored in the memory device 1100 together with the data. The ECC circuit 1230 may detect and correct an error of data read from the memory device 1100, based on the stored error correction code. When the error of the read data is not corrected by the ECC circuit 1230, the data recovery read operation may be performed.

As described above, the data storage device 1000A may determine the read voltage level for the data recovery read operation, based on a count value of a victim group. For example, the data storage device 1000A may divide a state of a threshold voltage distribution of a victim wordline into at least two sub-states and may determine the optimal offset voltage based on a comparison result of count values of the at least two sub-states. Accordingly, the optimal data recovery read operation may be performed even in various deterioration situations.

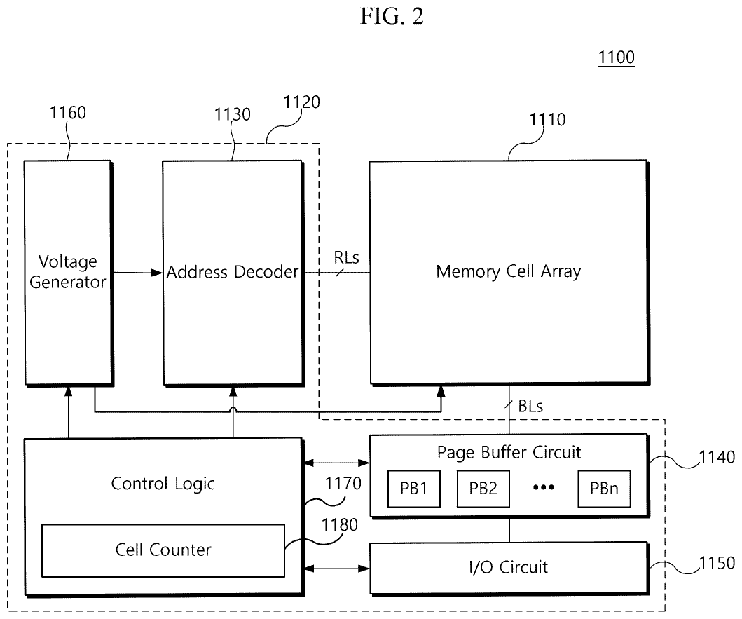

FIG. 2 is a block diagram illustrating an example of a memory device. The memory device 1100 of FIG. 2 may correspond to the memory device 1100 of FIG. 1.

Referring to FIG. 2, the memory device 1100 may include the memory cell array 1110 and a peripheral circuit 1120, and the peripheral circuit 1120 may include an address decoder 1130, a page buffer circuit 1140, an input/output circuit 1150, the voltage generator 1160, the control logic 1170, and a cell counter 1180.

The memory cell array 1110 may include a plurality of memory blocks. Each of the memory blocks may have a two-dimensional structure or a three-dimensional structure. Memory cells of a memory block with the two-dimensional structure (or a horizontal (or planar) structure) may be formed in a direction parallel to a substrate. Memory cells of a memory block with the three-dimensional structure (or a vertical structure) may be formed in a direction perpendicular to the substrate.

The plurality of memory blocks may be implemented with at least one of a single level cell block including SLCs, a multi-level cell block including MLCs, a triple level cell block including TLCs, and a quad level cell block including QLCs. Alternatively, for example, some of the plurality of memory blocks included in the memory cell array 1110 may be implemented with a single level cell block, and the others thereof may be implemented with a multi-level cell block or a triple level cell block.

The plurality of memory cells of the memory cell array 1110 may correspond to any one of a plurality of states. For example, when an erase voltage is applied to the memory cell array 1110, memory cells to which the erase voltage is applied may change to an erase state. For example, when a program voltage is applied to the memory cell array 1110, memory cells to which the program voltage is applied may change to a program state. Each memory cell may correspond to the erase state or any one of at least one program state, depending on a threshold voltage.

In the data recovery read operation, each state of the victim wordline may be divided into a plurality of sub-states. For example, the program state may be divided into a first sub-program state and a second sub-program state, the first sub-program state may be formed of memory cells belonging to a first victim group, and the second sub-program state may be formed of memory cells belonging to a second victim group.

The address decoder 1130 may be connected to the memory cell array 1110 through row lines RLs. The row lines RLs may include string selection lines SSLs, ground selection lines GSLs, wordlines WLs, dummy wordlines DWLs, and GIDL lines GIDLs.

In the read operation and/or the data recovery read operation, the address decoder 1130 may select a memory block targeted for the read operation from among the plurality of memory blocks under control of the control logic 1170. Afterwards, the address decoder 1130 may select a wordline targeted for the read operation and/or the data recovery read operation under control of the control logic 1170.

The page buffer circuit 1140 may be connected to the memory cell array 1110 through bitlines BLs. The page buffer circuit 1140 may temporarily store data to be programed at a selected page or data read from the selected page.

In the read operation and/or the data recovery read operation, the page buffer circuit 1140 may operate as a sense amplifier to sense data stored in a selected memory cell through a selected bitline. Alternatively, in the program operation, the page buffer circuit 1140 may operate as a write driver to input data to be stored to the memory cell array 1110.

The page buffer circuit 1140 may include a plurality of page buffers PB1 to PBn respectively connected to the plurality of bitlines BLs. The plurality of page buffers PB1 to PBn may be disposed to correspond to the bitlines BLs, respectively, and each of the plurality of page buffers PB1 to PBn may include at least one latch.

In some implementations, at least one of the latches of each page buffer may be used to calculate a count value for memory cells corresponding to a first area of a first victim group.

Alternatively, in some implementations, at least one of the latches of each page buffer may be used to calculate a count value for memory cells corresponding to a second area of a second victim group.

Alternatively, in some implementations, at least one of the latches of each page buffer may be used to store information about a victim group of a memory cell connected through a bitline.

The input/output circuit 1150 may be connected to the page buffer circuit 1140 through data lines DLs internally and may be connected to the memory controller 1200 (refer to FIG. 1) through input/output lines externally.

The voltage generator 1160 may generate various voltages necessary for the memory device 1100 to operate. For example, the voltage generator 1160 may be configured to generate various voltages, which are provided to the row lines RLs or the bitlines BLs depending on the operation of the memory device 1100, such as a plurality of program voltages, a plurality of program verify voltages, a plurality of pass voltages, a plurality of read voltages, a plurality of read pass voltages, and a plurality of erase voltages.

In the read operation, the voltage generator 1160 may generate the read voltage to be provided to a selected wordline and may generate the read pass voltage to be provided to unselected wordlines.

In the data recovery read operation, the optimal offset voltage may be applied depending on a deterioration situation. In this case, the voltage generator 1160 may generate the read voltage for the data recovery read operation to which the optimal offset voltage is applied.

The control logic 1170 may control all the operations of the memory device 1100 in response to a command and an address provided from the memory controller 1200. The control logic 1170 may further include the cell counter 1180 which performs a cell count operation for a victim group in the data recovery read operation.

The cell counter 1180 may count the number of memory cells corresponding to a specific threshold voltage range from the data sensed by the page buffer circuit 1140. That is, the cell counter 1180 may generate a count value indicating the number of memory cells corresponding to the specific threshold voltage range.

In the data recovery read operation, the cell counter 1180 may count the number of memory cells corresponding to the first area of the first victim group and may count the number of memory cells corresponding to the second area of the second victim group. For example, first, the cell counter 1180 may count the number of memory cells belonging to a predetermined threshold voltage range in the program state, regardless of a kind of a victim group. Afterwards, the cell counter 1180 may perform a group masking operation. In this case, the number of memory cells corresponding to a predetermined area of the victim group may be counted.

Meanwhile, in FIG. 2, the description is given as the cell counter 1180 is included in the control logic 1170. However, this is provided as an example, and the present disclosure is not limited thereto. For example, the cell counter 1180 may be implemented with an independent circuit separated from the control logic 1170.

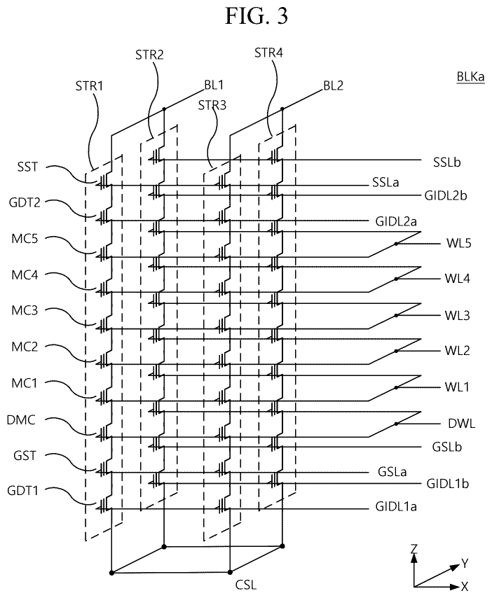

FIG. 3 is a circuit diagram illustrating an example memory block among a plurality of memory blocks. A memory block BLKa of FIG. 3 may be a memory block included in the memory cell array 1110 of FIGS. 1 and 2. For convenience of description, it is assumed that four strings STR1 to STR4 are included in one memory block.

Referring to FIG. 3, the memory block BLKa may include the plurality of strings STR1 to STR4 vertically stacked on a substrate. The plurality of strings STR1 to STR4 may be arranged in a first direction (i.e., an X-axis direction) and a second direction (i.e., a Y-axis direction).

Strings located at the same column from among the plurality of strings STR1 to STR4 may be connected to the same bitline. For example, the first and second strings STR1 and STR2 may be connected to a bitline line BL1, and the third and fourth strings STR3 and STR4 may be connected to a second bitline BL2.

Each of the plurality of strings STR1 to STR4 may include a plurality of cell transistors. Each of the plurality of cell transistors may include a charge trap flash (CTF) memory cell, but the present disclosure is not limited thereto. The plurality of cell transistors may be stacked in a third direction (i.e., a Z-axis direction).

The plurality of strings STR1 to STR4 may be connected in common to a common source line CSL. For example, as illustrated in FIG. 3, the common source line CSL may be connected in common to lower ends of the plurality of strings STR1 to STR4. However, this is provided as an example. It is sufficient if the common source line CSL is electrically connected to the lower ends of the strings STR1 to STR4, and the present disclosure is not limited to the case that the common source line CSL is physically located at the lower ends of the strings STR1 to STR4. Below, for convenience of description, a structure and a configuration of a string will be described based on the first string STR1. The remaining strings STR2, STR3, and STR3 may be similar in structure to the first string STR1, and thus, additional description will be omitted to avoid redundancy.

The plurality of cell transistors may be connected in series between the first bitline BL1 and the common source line CSL. For example, the plurality of cell transistors may include GIDL transistors GDT1 and GDT2, a string selection transistor SST, memory cells MC1 to MC5, a dummy memory cell DMC, and ground selection transistors GST.

The first GIDL transistors GDT1 may be disposed at the lowermost end of the first bitline BL1. For example, the first GIDL transistor GDT1 may be connected to the common source line CSL at the lower end of the string STR1. However, this is provided as an example, and the present disclosure is not limited thereto. A gate of the first GIDL transistor GDT1 may be connected to a first GIDL line GIDL1a.

The second GIDL transistor GDT2 may be disposed at an upper end of the string STR1, in detail, may be disposed between the string selection transistor SST and the memory cell MC5. That is, the second GIDL transistor GDT2 may be connected to the first bitline BL1 through the string selection transistor SST. A gate of the second GIDL transistor GDT2 may be connected to a second GIDL line GIDL2a.

The GIDL transistors GDT1 and GDT2 are illustrated in FIG. 3 as being provided at the upper end and the lower end of the string STR1. However, this is provided as an example. According to some implementations, the GIDL transistor may be provided only at the upper end of the string STR1, or the GIDL transistor may be provided only at the lower end of the string STR1.

One string selection transistor SST may be disposed at the uppermost end of the string STR1. The string selection transistor SST may be connected to the first bitline BL1 at the upper end of the string STR1. A gate of the string selection transistor SST may be connected to a string selection line SSLa. However, this is provided as an example. According to some implementations, a plurality of string selection transistors which are connected in series may be provided between the first bitline BL1 and the second GIDL transistor GDT2.

One ground selection transistor GST may be provided between the dummy memory cell DMC and the first GIDL transistor GDT1. A gate of the ground selection transistor GST may be connected to a ground selection line GSLa. However, this is provided as an example. According to some implementations, a plurality of ground selection transistors which are connected in series may be provided between the dummy memory cell DMC and the first GIDL transistor GDT1.

The first to fifth memory cells MC1 to MC5 may be connected in series between the string selection transistor SST and the dummy memory cell DMC. Gates of the first to fifth memory cells MC1 to MC5 may be respectively connected to first to fifth wordlines WL1 to WL5.

One dummy memory cell DMC may be provided between the first memory cell MC1 and the first GIDL transistor GDT1. A gate of the dummy memory cell DMC may be connected to a dummy wordline DWL. However, this is provided as an example. According to some implementations, a plurality of dummy memory cells which are connected in series may be provided between the first memory cell MC1 and the first GIDL transistor GDT1. Alternatively, an additional dummy memory cell may be provided between the string selection transistor SST and the fifth memory cell MC5. Alternatively, an additional dummy memory cell may be provided between the memory cells MC1 to MC5. Alternatively, the dummy memory cell DMC may not be provided.

In some implementations, when data read through the read operation are not corrected by the ECC circuit 1230, the data recovery read operation may be performed. In this case, a wordline where the read operation is failed may be referred to as a “victim wordline”, and a wordline adjacent to a victim wordline may be referred to as an “aggressor wordline”.

For example, it is assumed that the read operation for the third wordline WL3 is performed and the read data are not corrected by the ECC circuit 1230. In this case, the third wordline WL3 where correction is not made by the ECC circuit 1230 may be referred to as a “victim wordline”. At least one wordline adjacent to the third wordline WL3 being a victim wordline from among the plurality of wordlines WL1 to WL5 may be referred to as an “aggressor wordline”. For example, the second wordline WL2 adjacent to the third wordline WL3 may be an adjacent wordline. As another example, the fourth wordline WL4 adjacent to the third wordline WL3 may be an aggressor wordline. As another example, the second and fourth wordlines WL2 and WL4 adjacent to the third wordline WL3 may be adjacent wordlines. In the specification, for convenience of description, it is assumed that a wordline located at a lower end of a victim wordline is an aggressor wordline.

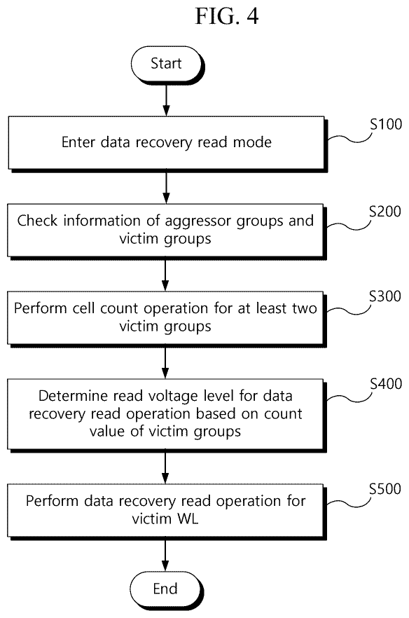

FIG. 4 is a flowchart for describing an example of a data recovery read operation.

Referring to FIG. 4, in operation S100, the data storage device 1000A (refer to FIG. 1) may enter a data recovery read mode.

For example, when data read by the read operation are not corrected by the ECC circuit 1230 (refer to FIG. 1), the data storage device 1000A may enter the data recovery read mode. In this case, a wordline where correction by the ECC circuit 1230 is failed due to deterioration may be referred to as a “victim wordline”. At least one wordline adjacent to the victim wordline may be referred to as an “aggressor wordline”.

In operation S200, information about aggressor groups of the aggressor wordline and information about victim groups of the victim wordline may be checked.

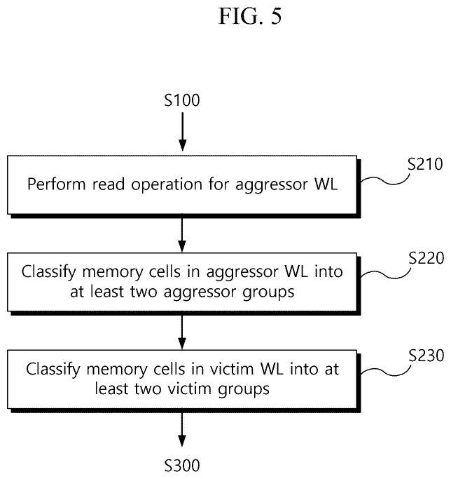

For example, the data storage device 1000A may perform the read operation for the aggressor wordline and may classify memory cells connected to the aggressor wordline into at least two aggressor groups. Afterwards, the data storage device 1000A may classify memory cells connected to the victim wordline into at least two victim groups based on information about aggressor groups. This will be described in detail with reference to FIG. 5 to FIG. 11.

In operation S300, the cell count operation for the at least two victim groups may be performed.

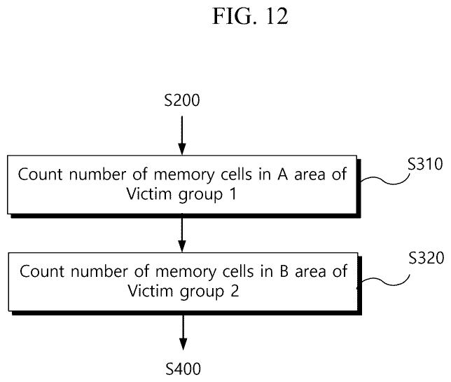

For example, the data storage device 1000A may perform the cell count operation for a first area of a first sub-state belonging to a first victim group. Also, the data storage device 1000A may perform the cell count operation for a second area of a second sub-state belonging to a second victim group. This will be described in detail with reference to FIGS. 12, 13, and 21 to 30.

In operation S400, the read voltage level for the data recovery read operation may be determined based on a count value corresponding to each of the at least two victim groups.

For example, the data storage device 1000A may compare a count value of memory cells corresponding to the first area of the first victim group and a count value of memory cells corresponding to the second area of the second victim group. The data storage device 1000A may determine a level of the offset voltage to be applied to the data recovery read operation, based on a comparison result.

For example, when the count value of the memory cells corresponding to the first area of the first victim group and the count value of the memory cells corresponding to the second area of the second victim group are equal or are smaller than a reference value, the data storage device 1000A may determine the read voltage level for the data recovery read operation by using a relatively great offset voltage.

For example, when a difference between the count value of the memory cells corresponding to the first area of the first victim group and the count value of the memory cells corresponding to the second area of the second victim group is greater than the reference value, the data storage device 1000A may determine the read voltage level for the data recovery read operation by using a relatively small offset voltage.

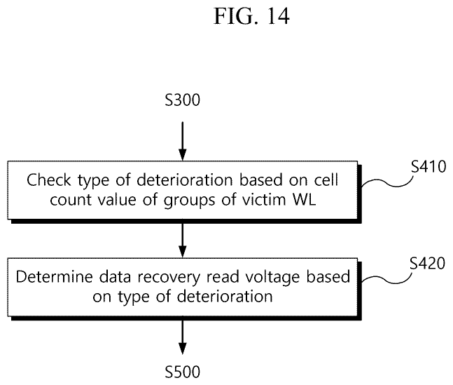

This will be described in detail with reference to FIG. 14 to FIG. 20B.

In operation S500, the data recovery read operation for the victim wordline may be performed by using the determined read voltage level.

For example, the data storage device 1000A may generate the read voltage level for the data recovery read operation determined in operation S400 and may perform the data recovery read operation for the victim wordline by using the read voltage level.

As described above, the data recovery read operation may determine the read voltage level for the data recovery read operation, based on a count value of a victim group. Accordingly, the optimal data recovery read operation may be performed in various deterioration situations.

### Classification of Memory Cells of Victim Wordline into Plurality of Victim Groups Based on Read Operation for Aggressor Group

FIG. 5 is a flowchart for describing an example in which memory cells of a victim wordline are classified into a plurality of victim groups. An operation of FIG. 5 may correspond, for example, to operation S200 of FIG. 4.

Referring to FIG. 5, in operation S210, the read operation for the aggressor wordline may be performed.

For example, the data storage device 1000A (refer to FIG. 1) may set at least one wordline adjacent to a wordline, in which the data recovery read operation will be performed, to the aggressor wordline. Afterwards, the data storage device 1000A may perform the read operation for the aggressor wordline.

In this case, the number of read voltages to be applied to the aggressor wordline and the voltage level may be determined depending on the number of aggressor groups corresponding to the aggressor wordline.

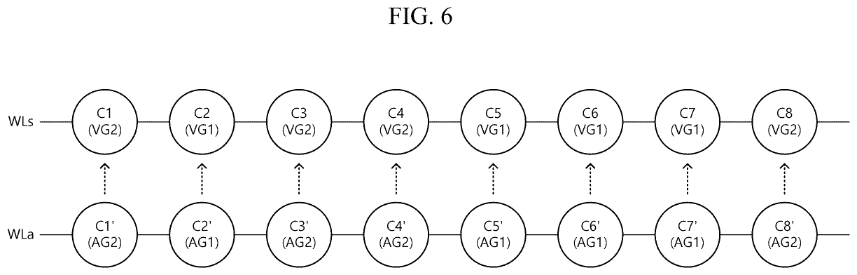

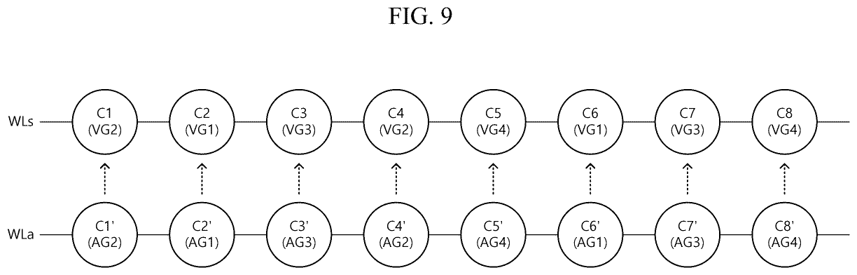

For example, as illustrated in FIG. 6, when the aggressor wordline is set as having two aggressor groups AG1 and AG2, one read voltage may be used in the read operation for the aggressor wordline. As another example, as illustrated in FIG. 9, when the aggressor wordline is set as having four aggressor groups AG1, AG2, AG3, and AG4, three read voltages may be used in the read operation for the aggressor wordline.

In operation S220, each of memory cells connected to the aggressor wordline may be classified as any one of at least two aggressor groups.

For example, when the aggressor wordline has two aggressor groups AG1 and AG2, each of the memory cells connected to the aggressor wordline may be classified as one aggressor group among the two aggressor groups AG1 and AG2 depending on a threshold voltage. As another example, when the aggressor wordline has four aggressor groups AG1, AG2, AG3, and AG4, each of the memory cells connected to the aggressor wordline may be classified as one aggressor group among the four aggressor groups AG1, AG2, AG3, and AG4 depending on a threshold voltage.

In operation S230, memory cells connected to the victim wordline may be classified as any one of at least two victim groups.

For example, the memory cells of the victim wordline and the memory cells of the aggressor wordline may be respectively coupled to each other. For example, each of the memory cells of the aggressor wordline line may be coupled to one memory cell being the most adjacent thereto from among the memory cells of the victim wordline.

In this case, each of the memory cells connected to the victim wordline may be classified as any one of at least two victim groups, based on group information of the corresponding memory cell of the aggressor wordline.

For example, it is assumed that each of the memory cells connected to the aggressor wordline is classified as any one of the two aggressor groups AG1 and AG2. When the memory cell of the aggressor wordline belongs to the first aggressor group AG1, the corresponding memory cell of the victim wordline may belong to the first victim group VG1. As another example, when the memory cell of the aggressor wordline belongs to the second aggressor group AG2, the corresponding memory cell of the victim wordline may belong to the second victim group VG2.

Likewise, it is assumed that each of the memory cells connected to the aggressor wordline is classified as any one of the four aggressor groups AG1, AG2, AG3, and AG4. When the memory cell of the aggressor wordline belongs to any one of the first to fourth aggressor groups AG1 to AG4, the corresponding memory cell of the victim wordline may also belong to any one of the first to fourth aggressor groups AG1 to AG4.

As described above, each of the memory cells of the victim wordline may be classified as any one of a plurality of victim groups, based on aggressor group information about the memory cells of the aggressor wordline.

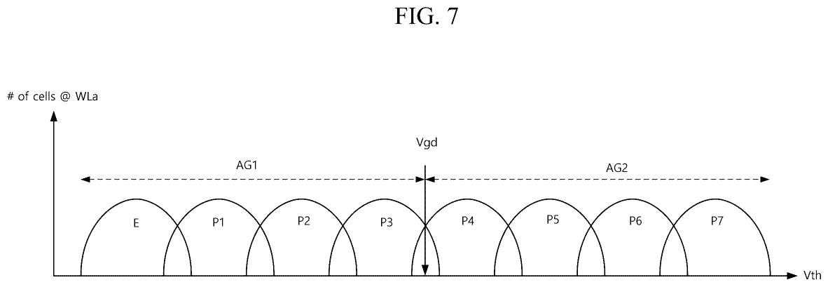

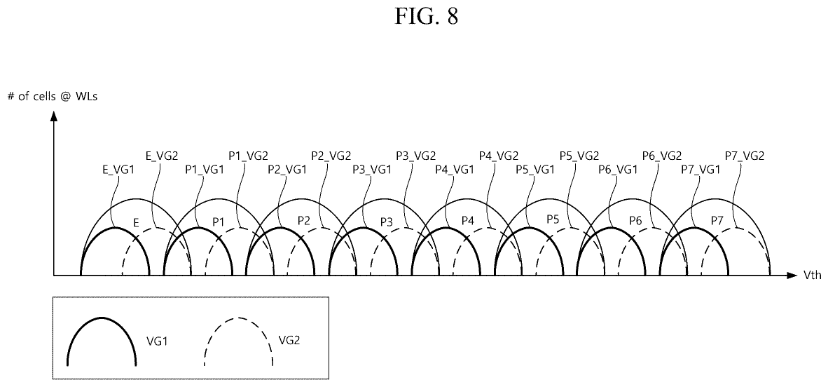

FIGS. 6, 7, and 8 are diagrams for describing an example in which memory cells of a victim wordline are classified into a plurality of victim groups based on a read operation for an aggressor group, in detail. In detail, an example in which a memory cell of a victim wordline is classified as any one of two victim groups based on aggressor group information of a memory cell of an aggressor wordline coupled thereto is illustrated in FIG. 6. An example in which a memory cell of an aggressor wordline is classified as one of two aggressor groups depending on a threshold voltage is illustrated in FIG. 7. An example in which a state of a threshold voltage distribution of memory cells of a victim group is divided into two victim groups is illustrated in FIG. 8.

For convenience of description, in FIGS. 6 to 8, it is assumed that the number of aggressor groups is 2 and the number of victim groups is 2. Also, it is assumed that each of a victim wordline WLs and an aggressor wordline WLa includes eight memory cells C1 to C8.

Referring to FIG. 6, the aggressor wordline WLa may be a single wordline. For example, when the victim wordline WLs is a wordline located at the uppermost end like the fifth wordline WL5 illustrated in FIG. 3, the aggressor wordline WLa may be the fourth wordline WL4. As another example, when the victim wordline WLs is a wordline located at the lowermost end like the first wordline WL1 illustrated in FIG. 3, the aggressor wordline WLa may be the second wordline WL2. As another example, when the victim wordline WLs is a wordline located on a middle portion like the third wordline WL3 illustrated in FIG. 3, the aggressor wordline WLa may be any one of the second wordline WL2 or the fourth wordline WL4.

The plurality of memory cells C1 to C8 connected to the victim wordline WLs may be respectively adjacent to a plurality of memory cells C1′ to C8′ connected to the aggressor wordline WLa. For example, the first memory cell C1 of the victim wordline WLs may be adjacent to the first memory cell C1′ of the aggressor wordline WLa, and the second memory cell C2 of the victim wordline WLs may be adjacent to the second memory cell C2′ of the aggressor wordline WLa. As in the above description, the eighth memory cell C8 of the victim wordline WLs may be adjacent to the eighth memory cell C8′ of the aggressor wordline WLa.

Each memory cell of the victim wordline WLs may be coupled to the corresponding, that is, adjacent memory cell of the aggressor wordline WLa, and thus, each memory cell of the victim wordline WLs may experience deterioration.

For example, it is assumed that the memory cells C2′, C5′, C6′, and C7′ of the aggressor wordline WLa belong to the first aggressor group AG1, as illustrated in FIGS. 6 and 7. For example, the memory cells C2′, C5′, C6′, and C7′ whose threshold voltages are lower than a group determination read voltage Vgd may be classified as the first aggressor group AG1. In other words, the memory cells C2′, C5′, C6′, and C7′ whose threshold voltages correspond to an erase state “E” and first to third program states P1 to P3 may be classified as the first aggressor group AG1.

In this case, the memory cells C2, C5, C6, and C7 of the victim wordline WLs, which are coupled to the memory cells C2′, C5′, C6′, and C7′ of the aggressor wordline WLa, may experience relatively small deterioration. In other words, because a threshold voltage corresponding to the first aggressor group AG1 is lower than a threshold voltage corresponding to the second aggressor group AG2, the degree of deterioration of the memory cells C2, C5, C6, and C7 of the victim wordline WLs may be relatively small. The memory cells C2, C5, C6, and C7 of the victim wordline WLs, which are relatively small in the degree of deterioration, may be classified as the first victim group VG1.

As another example, it is assumed that the memory cells C1′, C3′, C4′, and C8′ of the aggressor wordline WLa belong to the second aggressor group AG2, as illustrated in FIGS. 6 and 7. For example, the memory cells C1′, C3′, C4′, and C8′ whose threshold voltages are higher than the group determination read voltage Vgd may be classified as the second aggressor group AG2. In other words, the memory cells C1′, C3′, C4′, and C8′ whose threshold voltages correspond to fourth to seventh program states P4 to P7 may be classified as the second aggressor group AG2.

In this case, the memory cells C1, C3, C4, and C8 of the victim wordline WLs, which are coupled to the memory cells C1′, C3′, C4′, and C8′ of the aggressor wordline WLa, may experience relatively great deterioration. In other words, because the threshold voltage corresponding to the second aggressor group AG2 is greater than the threshold voltage corresponding to the first aggressor group AG1, the degree of deterioration of the memory cells C1, C3, C4, and C8 of the victim wordline WLs may be relatively great. The memory cells C1, C3, C4, and C8 of the victim wordline WLs, which are relatively great in the degree of deterioration, may be classified as the second victim group VG2.

Referring to FIG. 8, each state of a threshold voltage distribution of memory cells connected to the victim wordline WLs may be divided into two sub-states depending on the corresponding victim group.

For example, the erase state “E” of the threshold voltage distribution may be divided into a first sub-erase state E_VG1 and a second sub-erase state E_VG2. The first sub-erase state E_VG1 may belong to the first victim group VG1, and the second sub-erase state E_VG2 may belong to the second victim group VG2. In this case, a sum of the area of the first sub-erase state E_VG1 and the area of the second sub-erase state E_VG2 may be equal to the area of the erase state “E”.

As in the above description, each of the first to seventh program states P1 to P7 of the threshold voltage distribution may be divided into two sub-states. In this case, first sub-states P1_VG1, P2_VG1, P3_VG1, P4_VG1, P5_VG1, P6_VG1, P7_VG1, and P8_VG1 may belong to the first victim group VG1, and second sub-states P1_VG2, P2_VG2, P3_VG2, P4_VG2, P5_VG2, P6_VG2, P7_VG2, and P8_VG2 may belong to the second victim group VG2. A sum of the areas of the first sub-state and the second sub-state corresponding to one program state may be equal to the area of the corresponding program state.

As described above, each of memory cells of a victim wordline may be classified as any one of first and second victim groups, based on first and second aggressor group information about memory cells of an aggressor wordline. That is, a state of a threshold voltage distribution of a victim wordline may be divided into a first sub-state and a second sub-state.

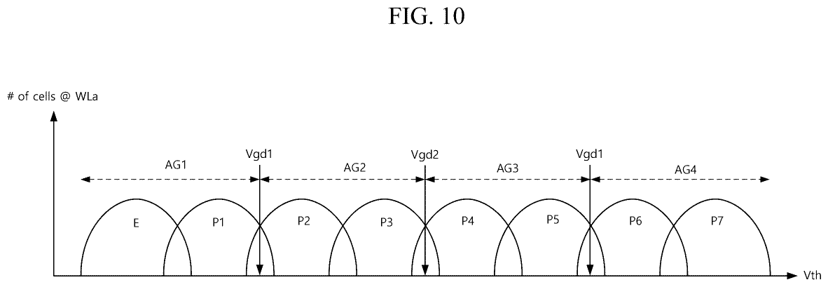

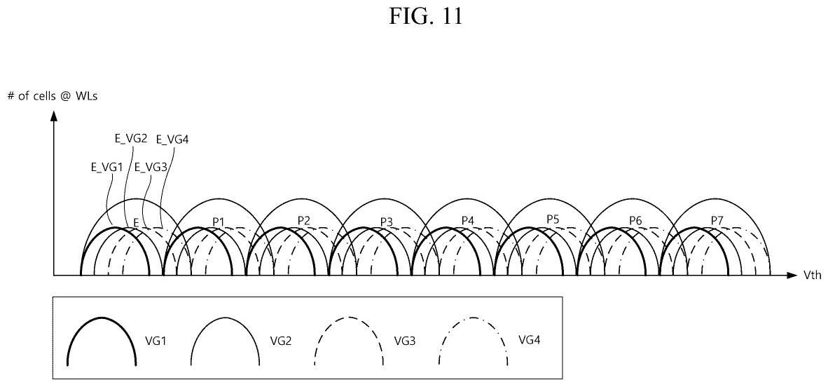

FIGS. 9, 10, and 11 are diagrams for describing an example in which memory cells of a victim wordline are classified into a plurality of victim groups based on a read operation for an aggressor group, in detail. In detail, an example in which a memory cell of a victim wordline is classified as any one of four victim groups based on aggressor group information of a memory cell of an aggressor wordline coupled thereto is illustrated in FIG. 9. An example in which a memory cell of an aggressor wordline is classified as one of fourth aggressor groups depending on a threshold voltage is illustrated in FIG. 10. An example in which a state of a threshold voltage distribution of memory cells of a victim group is divided into four victim groups is illustrated in FIG. 11.

A configuration and an operation to be described with reference to FIGS. 9 to 11 are similar to those described with reference to FIGS. 6 and 8, and thus, additional description will be omitted to avoid redundancy.

Referring to FIG. 9, each memory cell of the victim wordline WLs may be coupled to the adjacent memory cell of the aggressor wordline WLa, and thus, each memory cell of the victim wordline WLs may experience deterioration.

For example, it is assumed that the memory cells C2′ and C6′ of the aggressor wordline WLa have a threshold voltage lower than a first group determination read voltage Vgd1, the memory cells C1′ and C4′ of the aggressor wordline WLa have a threshold voltage between the first group determination read voltage Vgd1 and a second group determination read voltage Vgd2, the memory cells C3′ and C7′ of the aggressor wordline WLa have a threshold voltage between the second group determination read voltage Vgd2 and a third group determination read voltage Vgd3, and the memory cells C5′ and C8′ of the aggressor wordline WLa have a threshold voltage greater than between a third group determination read voltage Vgd3, as illustrated in FIGS. 9 and 10.

According to the above assumption, the memory cells C2′ and C6′ of the aggressor wordline WLa may be classified as the first aggressor group AG1, the memory cells C1′ and C4′ of the aggressor wordline WLa may be classified as the second aggressor group AG2, the memory cells C3′ and C7′ of the aggressor wordline WLa may be classified as the third aggressor group AG3, and the memory cells C5′ and C8′ of the aggressor wordline WLa may be classified as the fourth aggressor group AG4.

In this case, the memory cells C2 and C6 of the victim wordline WLs may be classified as the first victim group VG1, based on aggressor group information about memory cells of the aggressor wordline WLa coupled thereto. Also, the memory cells C1 and C4 may be classified as the second victim group VG2, the memory cells C3 and C7 may be classified as the third victim group VG3, and the memory cells C5 and C8 may be classified as the fourth victim group VG4.

Referring to FIG. 11, each state of a threshold voltage distribution of memory cells connected to the victim wordline WLs may be divided into 4 sub-states depending on the corresponding victim group.

For example, the erase state “E” of the threshold voltage distribution may be divided into a first sub-erase state E_VG1, a second sub-erase state E_VG2, a third sub-erase state E_VG3, and a fourth sub-erase state E_VG4. The first to fourth sub-erase states E_VG1, E_VG2, E_VG3, and E_VG4 may respectively belong to the first to fourth victim groups VG1, VG2, VG3, and VG4. In this case, a sum of the areas of the first to fourth sub-erase states E_VG1, E_VG2, E_VG3, and E_VG4 may be equal to the area of the erase state “E”.

As in the above description, each of the first to seventh program states P1 to P7 of the threshold voltage distribution may be divided into four sub-states. A sum of the areas of the four sub-states corresponding to one program state may be equal to the area of the corresponding program state.

As described above, each of memory cells of a victim wordline may be classified as any one of first to fourth victim groups, based on first to fourth aggressor group information about memory cells connected to an aggressor wordline. According to the above description, each state of a threshold voltage distribution of memory cells connected to a victim wordline may be divided into first to fourth sub-states. The first to fourth sub-states may respectively correspond to the first to fourth victim groups.

### Execution of Cell Count Operation for at Least Two Victim Groups

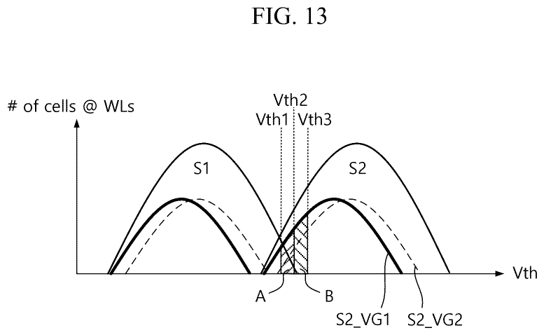

FIG. 12 is a flowchart for describing an example of a cell count operation for at least two victim groups. FIG. 13 is a diagram illustrating an example of a first area of a first victim group and a second area of a second victim group, in which a cell count operation is performed. An operation of FIG. 12 may correspond, for example, to operation S300 of FIG. 4.

Referring to FIGS. 12 and 13, in operation S310, the number of memory cells of the first area of the first victim group may be counted.

For example, it is assumed that a threshold voltage distribution of memory cells connected to the victim wordline WLs has a first state S1 and a second state S2, as illustrated in FIG. 13. For example, the first state S1 may correspond to any one of the erase state “E” and the first to sixth program states P1 to P6 of FIG. 11, and the second state S2 may correspond to any one of the first to seventh program states P1 to P7 of FIG. 11. For example, the first state S1 may be the erase state “E”, and the second state S2 may be the first program state P1. As another example, the first state S1 may be the first program state P1, and the second state S2 may be the second program state P2.

Each of the first state S1 and the second state S2 may be divided into a plurality of sub-states. For example, the second state S2 may be divided into a first sub-state S2_VG1 and a second sub-state S2_VG2. The first sub-state S2_VG1 may belong to the first victim group VG1 (refer to FIGS. 8 and 11), and the second sub-state S2_VG2 may belong to the second victim group VG2 (refer to FIGS. 8 and 11). A sum of the area of the first sub-state S2_VG1 and the area of the second sub-state S2_VG2 may be equal to the area of the second state S2.

In this case, the data storage device 1000A may perform the cell count operation for memory cells corresponding to a first area “A” of the first sub-state S2_VG1. Herein, the memory cells corresponding to the first area “A” may indicate memory cells, which have threshold voltages between first and second threshold voltages Vth1 and Vth2, from among the memory cells of the first sub-state S2_VG1. According to the above description, a count value indicating the number of memory cells corresponding to the first area “A” of the first victim group VG1 may be obtained.

In operation S320, the number of memory cells of the second area of the second victim group may be counted.

For example, the data storage device 1000A may perform the cell count operation for memory cells corresponding to a second area “B” of the second sub-state S2_VG2. Herein, the memory cells corresponding to the second area “B” may indicate memory cells, which have threshold voltages between second and third threshold voltages Vth2 and Vth3, from among the memory cells of the second sub-state S2_VG2. According to the above description, a count value indicating the number of memory cells corresponding to the second area “B” of the second victim group VG2 may be obtained.

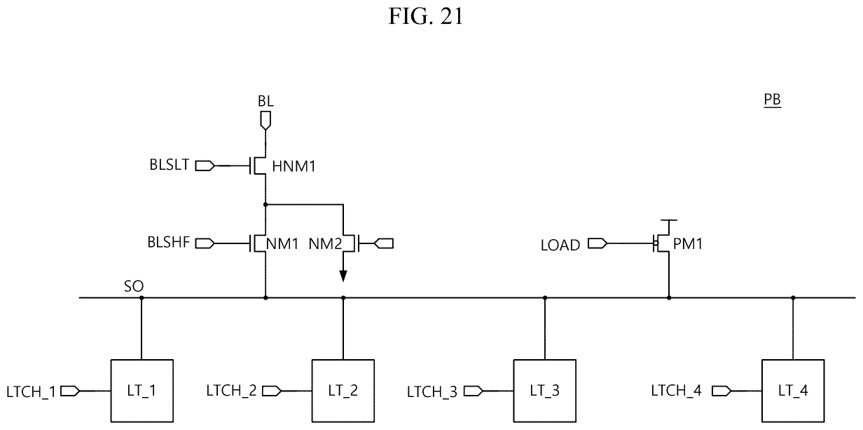

Meanwhile, a count operation for a first area of a first victim group and a count operation for a second area of a second victim group may be performed by using various methods, which will be described in detail with reference to FIGS. 21 to 29.

### Determination of Read Voltage Level in Data Recovery Read Operation Based on Count Value of Victim Group

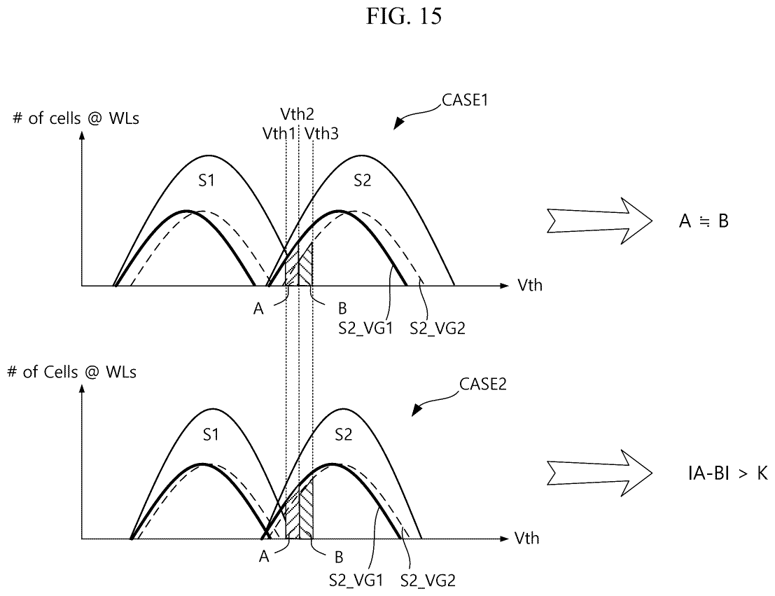

FIG. 14 is an example flowchart for describing how to determine a read voltage level for a data recovery read operation based on count values of at least two victim groups. FIG. 15 is a diagram illustrating an example in which a type of deterioration is checked depending on a comparison result of count values of at least two victim groups. An operation of FIG. 14 may correspond, for example, to operation S400 of FIG. 4.

Referring to FIGS. 14 and 15, in operation S410, a type of deterioration may be checked based on count values of at least two victim groups.

For example, referring to a first case CASE1 of FIG. 15, a count value of the first area “A” of the first sub-state S2_VG1 may be equal to a count value of the second area “B” of the second sub-state S2_VG2, or a difference between the count values may be smaller than a reference value. In this case, the data storage device 1000A may determine that deterioration of relatively great lateral spreading occurs. For example, deterioration of relatively great lateral spreading may occur at a high temperature.

As another example, referring to a second case CASE2 of FIG. 15, a difference between a count value of the first area “A” of the first sub-state S2_VG1 of the first victim group VG1 and a count value of the second area “B” of the second sub-state S2_VG2 of the second victim group VG2 may be greater than or equal to the reference value. In this case, the data storage device 1000A may determine that deterioration of relatively small lateral spreading occurs. For example, at a low temperature, the deterioration that the lateral spreading is relatively small and the vertical charge loss is relatively great may occur.

In operation S420, each, the read voltage level for the data recovery read operation may be determined based on the type of deterioration.

For example, like the first case CASE1, when the count value of the memory cells corresponding to the first area “A” of the first victim group VG1 and the count value of the memory cells corresponding to the second area “B” of the second victim group VG2 are equal or are smaller than the reference value, the data storage device 1000A may determine the read voltage level for the data recovery read operation by using a relatively great offset voltage.

As another example, when a difference between the count value of the memory cells corresponding to the first area “A” of the first victim group VG1 and the count value of the memory cells corresponding to the second area “B” of the second victim group VG2 is greater than the reference value, the data storage device 1000A may determine the read voltage level for the data recovery read operation by using a relatively small offset voltage.

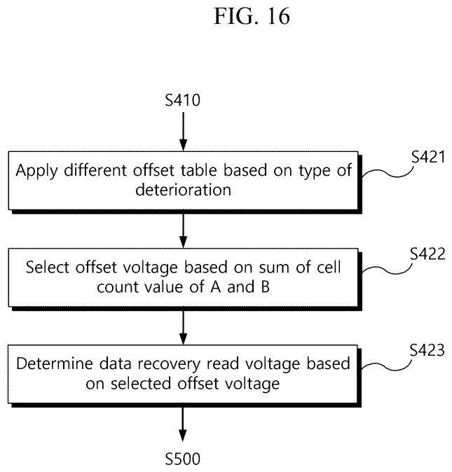

According to some implementations, the data storage device 1000A may determine the read voltage level by differently applying an offset table depending on a deterioration situation. This will be described in detail with reference to FIGS. 16 to 18B.

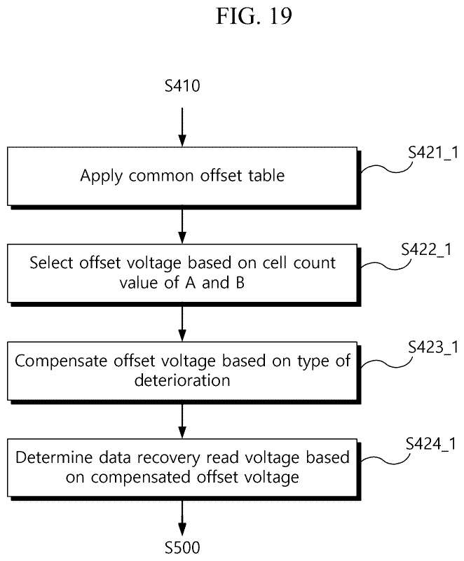

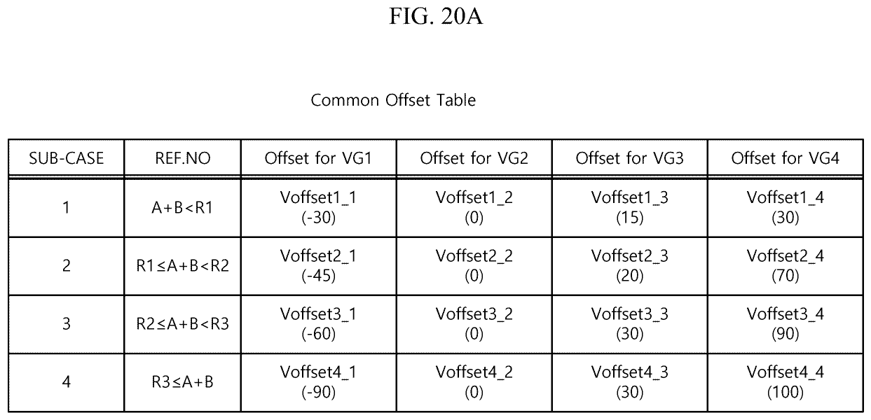

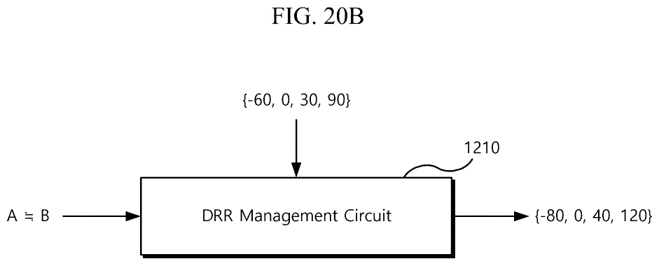

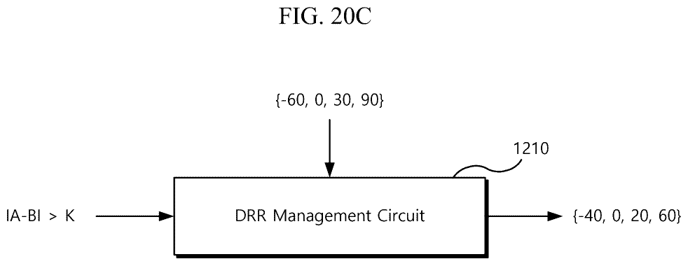

Alternatively, according to some implementations, the data storage device 1000A may apply the same offset table and may then compensate for an offset voltage level by using different values. This will be described in detail with reference to FIG. 19 to FIG. 20B.

### Apply Different Offset Tables to determine of Read Voltage Level for Data Recovery Read Operation Depending on Deterioration Situation

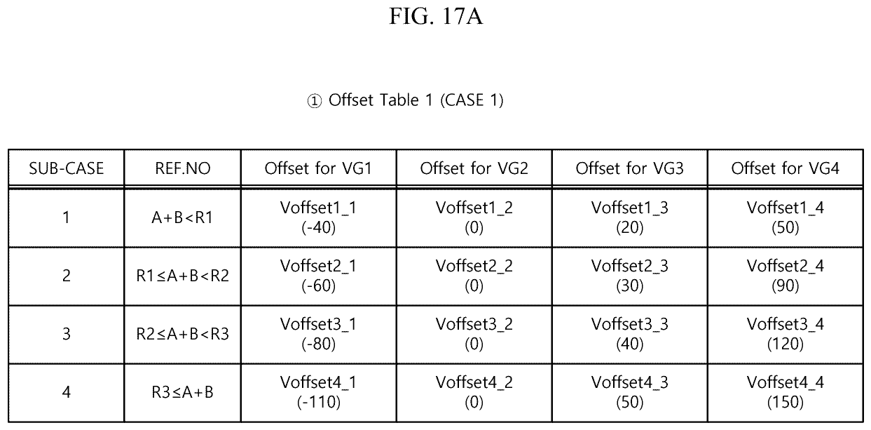

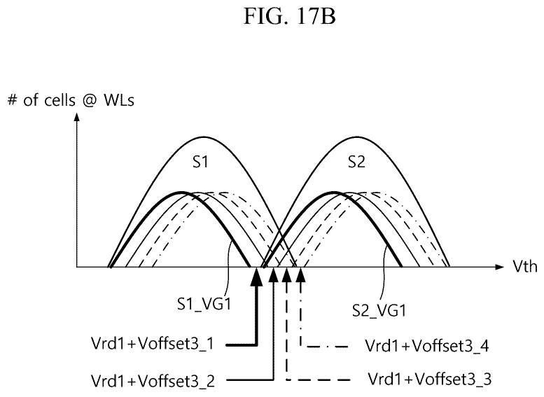

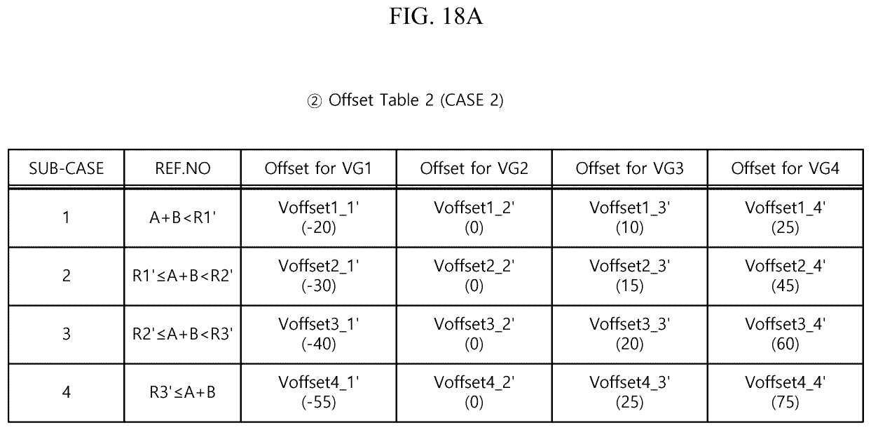

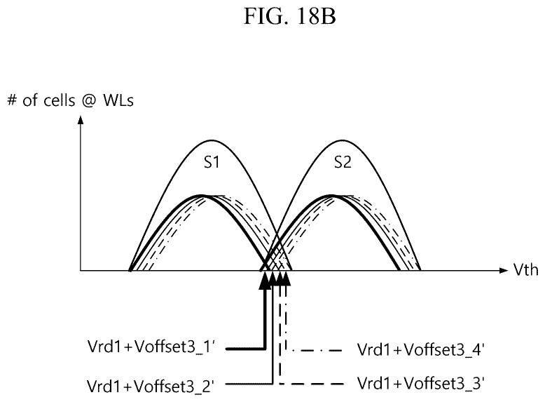

FIG. 16 is an example flowchart for determining a read voltage level for a data recovery read operation depending on a deterioration situation by applying different offset tables. FIG. 17A is a diagram illustrating an example of a first offset table applied in a deterioration situation where lateral spreading is relatively great. FIG. 17B is a diagram illustrating an example in which a read voltage level for a data recovery read operation is determined by applying a first offset table. FIG. 18A is a diagram illustrating an example of a second offset table applied in a deterioration situation where lateral spreading is relatively small. FIG. 18B is a diagram illustrating an example in which a read voltage level for a data recovery read operation is determined by using a second offset table.

An operation of FIG. 16 may correspond to operation S420 of FIG. 14. For convenience of description, in FIGS. 16 to 18B, it is assumed that a victim wordline corresponds to four victim groups VG1, VG2, VG3, and VG4.

Referring to FIGS. 16 to 18B, in operation S421, different offset tables may be applied depending on types of deterioration.

In some implementations, as illustrated in FIG. 17A, when there occurs the deterioration of the first case CASE1 in which deterioration of lateral spreading is relatively great, a first offset table in which magnitudes of offset voltages are relatively great may be applied.

In some implementations, as illustrated in FIG. 18A, when there occurs the deterioration of the second case CASE2 in which deterioration of lateral spreading is relatively small, a second offset table in which magnitudes of offset voltages are relatively small may be applied.

In operation S422, an offset voltage may be selected based on a sum of a count value of the first area “A” and a count value of the second area “B”.

In some implementations, as illustrated in FIG. 17A, the first offset table which is applied when deterioration of lateral spreading is relatively great may include a plurality of sub-cases. For example, the first offset table may include four sub-cases SUB-CASE1 to SUB-CASE4.

In this case, the four sub-cases SUB-CASE1 to SUB-CASE4 may be distinguished based on a sum of the count value of the first area “A” of the first victim group VG1 and the count value of the second area “B” of the second victim group VG2.

For example, when the sum of the count value of the first area “A” and the count value of the second area “B” is smaller than a first reference value R1, the offset voltages of the first sub-case SUB-CASE1 of the first case CASE1 may be applied to determine the read voltage level for the data recovery read operation. For example, as illustrated in FIG. 17A, an offset voltage Voffset1_1 to be applied to the first victim group VG1, an offset voltage Voffset1_2 to be applied to the second victim group VG2, an offset voltage Voffset1_3 to be applied to the third victim group VG3, and an offset voltage Voffset1_4 to be applied to the fourth victim group VG4 may be {−40, 0, 20, 50}.

As another, when the sum of the count value of the first area “A” and the count value of the second area “B” is equal to or greater than the first reference value R1 and is smaller than a second reference value R2, the offset voltages of the second sub-case SUB-CASE2 of the first case CASE1 may be applied to determine the read voltage level for the data recovery read operation. For example, as illustrated in FIG. 17A, the offset voltage Voffset1_1 to be applied to the first victim group VG1, the offset voltage Voffset1_2 to be applied to the second victim group VG2, the offset voltage Voffset1_3 to be applied to the third victim group VG3, and the offset voltage Voffset1_4 to be applied to the fourth victim group VG4 may be {−60, 0, 30, 90}.

As in the above description, when the sum of the count value of the first area “A” and the count value of the second area “B” is equal to or greater than a second reference value R2 and is smaller than a third reference value R3, the offset voltages of the third sub-case SUB-CASE3 of the first case CASE1 may be applied to determine the read voltage level for the data recovery read operation. Alternatively, when the sum of the count value of the first area “A” and the count value of the second area “B” is equal to or greater than the third reference value R3, the offset voltages of the fourth sub-case SUB-CASE4 of the first case CASE1 may be applied to determine the read voltage level for the data recovery read operation.

Also, in some implementations, as illustrated in FIG. 18A, the second offset table which is applied when deterioration of lateral spreading is relatively small may include a plurality of sub-cases. For example, the second offset table may include four sub-cases SUB-CASE1 to SUB-CASE4.

In this case, the four sub-cases SUB-CASE1 to SUB-CASE4 may be distinguished based on a sum of the count value of the first area “A” of the first victim group VG1 and the count value of the second area “B” of the second victim group VG2.

For example, when the sum of the count value of the first area “A” and the count value of the second area “B” is smaller than a first reference value R1′, the offset voltages of the first sub-case SUB-CASE1 of the second case CASE2 may be applied to determine the read voltage level for the data recovery read operation. For example, as illustrated in FIG. 18A, an offset voltage Voffset1_1′ to be applied to the first victim group VG1, an offset voltage Voffset1_2′ to be applied to the second victim group VG2, an offset voltage Voffset1_3′ to be applied to the third victim group VG3, and an offset voltage Voffset1_4′ to be applied to the fourth victim group VG4 may be {−20, 0, 10, 25}.

As in the above description, depending on a result of comparing the count value of the first area “A” and the count value of the second area “B”, the offset voltages of any one of the second to fourth sub-cases SUB-CASE2, SUB-CASE3, and SUB-CASE4 of the second case CASE2 may be applied to determine the read voltage level for the data recovery read operation.

In operation S423, the read voltage level for the data recovery read operation may be determined by the selected offset voltage.

For convenience of description, as illustrated in FIGS. 17A and 17B, it is assumed that the offset voltages of the third sub-case SUB-CASE3 of the first case CASE1 are selected to compensate for deterioration of relatively great lateral spreading. Also, in FIG. 17B, it is assumed that a first read voltage Vrd1 is a read voltage to be applied to distinguish the first state S1 and the second state S2 in a normal read operation.

In the data recovery read operation, the third sub-case SUB-CASE3 of the first case CASE1 may be applied.

In this case, a (3_1)-th offset voltage Voffset3_1 may be applied to the first read voltage Vrd1 to distinguish the sub-state S1_VG1 belonging to the first victim group VG1 of the first state S1 and the sub-state S2_VG1 belonging to the first victim group VG1 of the second state S2. Accordingly, the optimal read voltage for distinguishing the sub-state S1_VG1 corresponding to the first victim group VG1 of the first state S1 and the sub-state S2_VG1 corresponding to the first victim group VG1 of the second state S2 may be determined as “Vrd1+Voffset3_1”.

Likewise, a (3_2)-th offset voltage Voffset3_2 may be applied to the first read voltage Vrd1 to distinguish a sub-state belonging to the second victim group VG2 of the first state S1 and a sub-state belonging to the second victim group VG2 of the second state S2. Accordingly, the optimal read voltage for distinguishing the sub-state corresponding to the second victim group VG2 of the first state S1 and the sub-state corresponding to the second victim group VG2 of the second state S2 may be determined as “Vrd1+Voffset3_2”.

Accordingly, the optimal read voltage for distinguishing a sub-state corresponding to the third victim group VG3 of the first state S1 and a sub-state corresponding to the third victim group VG3 of the second state S2 may be determined as “Vrd1 +Voffset3_3”. The optimal read voltage for distinguishing a sub-state corresponding to the fourth victim group VG4 of the first state S1 and a sub-state corresponding to the fourth victim group VG4 of the second state S2 may be determined as “Vrd1+Voffset3_4”.

Also, in some implementations, as illustrated in FIGS. 18A and 18B, it is assumed that the offset voltages of the third sub-case SUB-CASE3 of the second case CASE2 are selected to compensate for deterioration of relatively small lateral spreading.

In this case, the optimal read voltage for distinguishing a sub-state corresponding to the first victim group VG1 of the first state S1 and a sub-state corresponding to the first victim group VG1 of the second state S2 may be determined as “Vrd1+Voffset3_1′”. The optimal read voltage for distinguishing a sub-state corresponding to the second victim group VG2 of the first state S1 and a sub-state corresponding to the second victim group VG2 of the second state S2 may be determined as “Vrd1+Voffset3_2′”. As in the above description, the optimal read voltage for distinguishing a sub-state corresponding to the third victim group VG3 of the first state S1 and a sub-state corresponding to the third victim group VG3 of the second state S2 may be determined as “Vrd1+Voffset3_3′”. The optimal read voltage for distinguishing a sub-state corresponding to the fourth victim group VG4 of the first state S1 and a sub-state corresponding to the fourth victim group VG4 of the second state S2 may be determined as “Vrd1+Voffset3_4′”.

As described above, a data storage device may apply different offset tables depending on deterioration situations and may select the optimal offset voltage among offset voltages of various magnitudes included in an offset table depending on a deterioration situation. Accordingly, the optimal data recovery read operation may be performed even in various deterioration situations

### Compensation for Offset Voltage by Applying the Same Offset Table and Using Different Values Depending on Deterioration situations

FIG. 19 is an example flowchart for determining a read voltage level for a data recovery read operation by compensating for an offset voltage by using different values depending on deterioration situations, with the same offset table applied. FIG. 20A is a diagram illustrating an example of a common offset table identically applied regardless of the degree of lateral spreading deterioration. FIG. 20B is a diagram illustrating an example of compensating for an offset voltage to be applied to the deterioration that lateral spreading is relatively great. FIG. 20C is a diagram illustrating an example of compensating for an offset voltage to be applied to the deterioration that lateral spreading is relatively small.

An operation of FIGS. 19 to 20C is similar to that of FIGS. 16 to 18B, and thus, additional description will be omitted to avoid redundancy. Also, for convenience of description, it may be assumed that the third sub-case SUB-CASE3 of the common offset table is selected.

Referring to FIGS. 19 to 20C, in operation S421_1, the same offset table may be applied regardless of a type of deterioration.

For example, as illustrated in FIG. 20A, the common offset table may be first applied regardless of a type of deterioration.

In operation S422_1, an offset voltage may be selected based on a sum of a count value of the first area “A” and a count value of the second area “B”.

In some implementations, as illustrated in FIG. 20A, the common offset table may include four sub-cases SUB-CASE1 to SUB-CASE4. Any one of the first to fourth sub-cases SUB-CASE1 to SUB-CASE4 may be selected based on a result of comparing the sum of the count value of the first area “A” and the count value of the second area “B” with the first to third reference values R1 to R3.

In operation S423_1, a selected offset voltage may be compensated for depending on a type of deterioration.

In some implementations, as illustrated in FIG. 20B, when a count value of memory cells corresponding to the first area “A” and a count value of memory cells corresponding to the second area “B” are equal or a difference between the count values is smaller than a reference value, the DRR management circuit 1210 may determine that the deterioration that lateral spreading is relatively great occurs.

In this case, the DRR management circuit 1210 may compensate for the offset voltage such that the offset voltage becomes greater. For example, the DRR management circuit 1210 may adjust offset voltages Voffset3_1, Voffset3_2, Voffset3_3, and Voffset3_4 of the third sub-case SUB-CASE3 from {−60, 0, 30, 90} to {−80, 0, 40, 120}.

In some implementations, as illustrated in FIG. 20C, when a difference between the count value of the memory cells corresponding to the first area “A” and the count value of the memory cells corresponding to the second area “B” is equal to or greater than the reference value, the DRR management circuit 1210 may determine that the deterioration that lateral spreading is relatively small occurs.

In this case, the DRR management circuit 1210 may compensate for the offset voltage such that the offset voltage becomes smaller. For example, the DRR management circuit 1210 may adjust the offset voltages Voffset3_1, Voffset3_2, Voffset3_3, and Voffset3_4 of the third sub-case SUB-CASE3 from {−60, 0, 30, 90} to {−40, 0, 20, 60}.

In operation S424_1, the read voltage level for the data recovery read operation may be determined by the selected offset voltage.

As described above, a data storage device may compensate for the offset voltage by using voltage values of different magnitudes depending on deterioration situations, with the same offset table applied. Accordingly, the optimal data recovery read operation may be performed even in various deterioration situations

### Method of Counting One Area of each of at Least Two Victim Groups Using Odd-Numbered Bitline and Even-Numbered Bitline

FIG. 21 is a block diagram schematically illustrating an example of a page buffer. A page buffer of FIG. 21 may correspond to any one of the page buffers PB1 to PBn of FIG. 2. For convenience, the description will be given with reference to FIG. 21 as a page buffer PB includes a plurality of latches LT_1, LT_2, LT_3, and LT_4. However, the present disclosure is not limited thereto. For example, the page buffer PB may be implemented to include only one latch.

Referring to FIG. 21, the page buffer PB may be connected to a bitline BL. The page buffer PB may include a sensing node SO connected to the bitline BL. Also, the page buffer PB may include the plurality of latches LT_1, LT_2, LT_3, and LT_4 each connected to the sensing node SO.

In the read operation and/or the data recovery read operation, the bitline BL may be precharged by the control logic 1170 (refer to FIG. 2). For example, when a load signal LOAD and a control signal BLSHF are activated, the bitline BL may be precharged with a specific level. In this case, a high-voltage transistor HNM1 may maintain a turn-on state by a bitline selection signal BLSLT.

Next, when the load signal LOAD is deactivated, charges charged at the sensing node SO flows to the bitline BL through a transistor NM1 turned on by the control signal BLSHF. For example, when a selected memory cell is an on cell, the charges charged at the sensing node SO may be discharged to the common source line CSL through a channel of a string connected to the bitline BL. In this case, because a current flowing from the sensing node SO to the bitline BL is relatively large, a speed at which a voltage of the sensing node SO decreases may be relatively fast.

In contrast, when the selected memory cell is an off cell, it is difficult for the charges charged at the sensing node SO to be discharged to the common source line CSL through the bitline BL. Accordingly, because a current flowing from the sensing node SO to the bitline BL is relatively small, a speed at which a voltage of the sensing node SO decreases may be relatively slow.

At least some of the plurality of latches LT_1, LT_2, LT_3, and LT_4 may be used to perform the cell count operation.

In some implementations, in the cell count operation for memory cells corresponding to a first area of a first victim group, the first latch LT_1 of the page buffer PB connected to an even-numbered bitline even BL such as a second bitline BL2 or a fourth bitline BL4 may be used to calculate a count value of the first area. In the cell count operation for memory cells corresponding to a second area of a second victim group, the first latch LT_1 of the page buffer PB connected to an odd-numbered bitline odd BL such as a first bitline BL1 or a third bitline BL3 may be used to calculate a count value of the second area.

In some implementations, in the cell count operation for the memory cells corresponding to the first area of the first victim group, the first latch LT_1 of the page buffer PB may be used to calculate the count value of the first area. In the cell count operation for the memory cells corresponding to the second area of the second victim group, the second latch LT_2 of the page buffer PB may be used to calculate the count value of the second area.

In some implementations, the third latch LT_3 of the page buffer PB may be used to store information about a victim group of the corresponding memory cell.

Below, a cell count operation according to various implementations of the present disclosure will be described in detail.

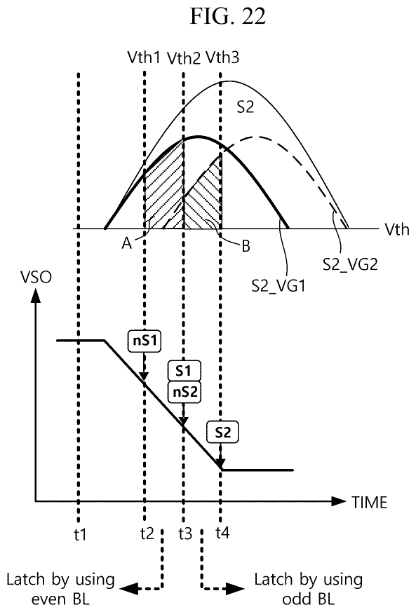

FIG. 22 is a diagram illustrating an example of a cell count operation for the first area “A” of the first victim group VG1 and the second area “B” of the second victim group VG2. An example in which a page buffer connected to an even-numbered bitline is used for the cell count operation for the first area “A” and a page buffer connected to an odd-numbered bitline is used for the cell count operation for the second area “B” is illustrated in FIG. 22.

For convenience of description, it is assumed that the second state S2 is divided into the first sub-state S2_VG1 belonging to the first victim group VG1 and the second sub-state S2_VG2 belonging to the second victim group VG2.

Referring to FIG. 22, first, a precharge operation may be performed.

For example, at a first time point t1, all values stored in latches of page buffers connected to bitlines may be initialized. For example, a value stored in the first latch LT_1 (refer to FIG. 21) of each page buffer may be initialized to “1”.

Afterwards, a first sensing operation may be performed.

For example, at a second time point t2, a value stored in the first latch LT_1 of a page buffer, which corresponds to a memory cell whose threshold voltage is equal to or greater than the first threshold voltage Vth1, from among page buffers connected to even-numbered bitlines may be changed from “1” to “0” in response to a latch signal nS1. Afterwards, at a third time point t3, a value stored in the first latch LT_1 of a page buffer, which corresponds to a memory cell whose threshold voltage is equal to or greater than the second threshold voltage Vth2, from among the page buffers connected to the even-numbered bitlines may be changed from “0” to “1” in response to a latch signal S1. Each of the latch signal nS1 and the latch signal S1 may correspond, for example, to a first latch signal LTCH_1 of FIG. 21.

According to the above description, information about memory cells located in an area between the first threshold voltage Vth1 and the second threshold voltage Vth2 of the second state S2 may be stored in the corresponding latches.

A second sensing operation may be performed by changing a sensing time point to be different from that of the first sensing operation.

For example, at the third time point t3, a value stored in a latch of a page buffer, which corresponds to a memory cell whose threshold voltage is equal to or greater than the second threshold voltage Vth2, from among page buffers connected to odd-numbered bitlines may be changed from “1” to “0” in response to a latch signal nS2. At a fourth time point t4, a value stored in the first latch LT_1 of a page buffer, which corresponds to a memory cell whose threshold voltage is equal to or greater than the third threshold voltage Vth3, from among the page buffers connected to the odd-numbered bitlines may be changed from “0” to “1” in response to a latch signal S2. Each of the latch signal nS2 and the latch signal S2 may correspond, for example, to the first latch signal LTCH_1 of FIG. 21.

According to the above description, information about memory cells located in an area between the second threshold voltage Vth2 and the third threshold voltage Vth3 from among the memory cells of the second state S2 may be stored in the corresponding latches.

Afterwards, memory cells belonging to the second sub-state S2_VG2 of the second victim group VG2 from among the memory cells located in the area between the first threshold voltage Vth1 and the second threshold voltage Vth2 of the second state S2 may be masked. Afterwards, the number of memory cells corresponding to the first area “A” of the first sub-state S2_VG1 may be counted.

Also, afterwards, memory cells belonging to the first sub-state S2_VG1 from among the memory cells located in the area between the second threshold voltage Vth2 and the third threshold voltage Vth3 of the second state S2 may be masked. Afterwards, the number of memory cells corresponding to the second area “B” of the second sub-state S2_VG2 may be counted.

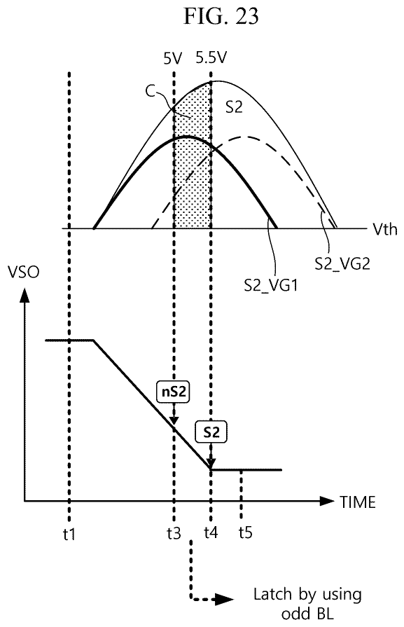

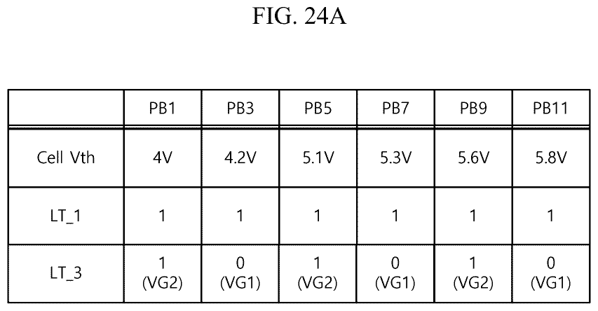

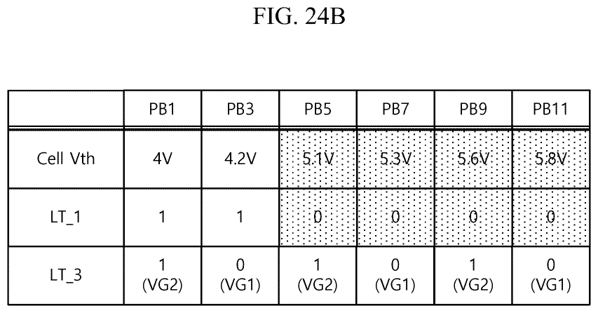

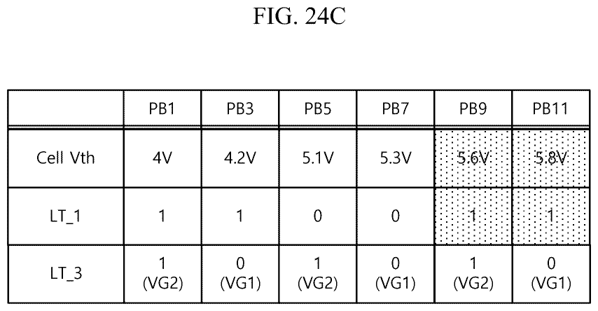

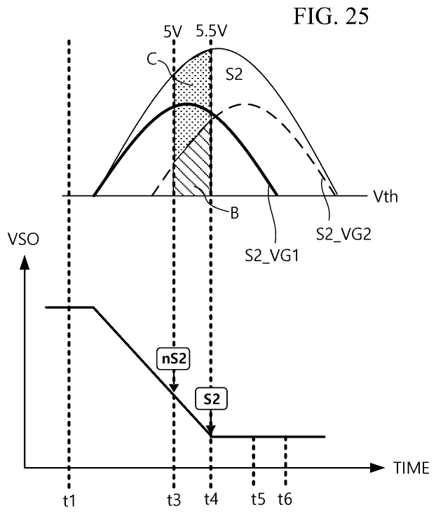

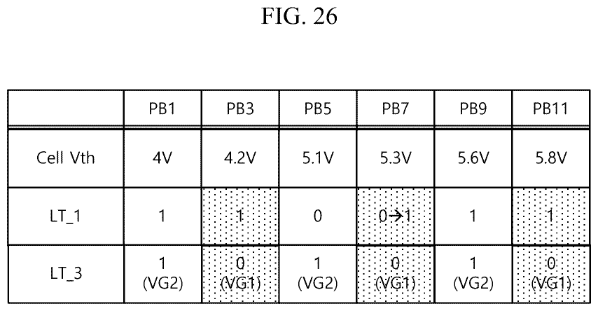

FIGS. 23, 24A, 24B, and 24C are diagrams for describing an example of an operation of sensing memory cells located in a third area “C” between the second threshold voltage Vth2 and the third threshold voltage Vth3 of the second state S2 in detail. FIGS. 25 and 26 are diagrams for describing an example of an operation of obtaining a count value of the second area “B” of the second sub-state S_VG2 by masking memory cells corresponding to the first sub-state S2_VG1 from among memory cells located in the third area “C” of the second state S2.

For convenience of description, it is assumed that the second threshold voltage Vth2 is 5 V and the third threshold voltage Vth3 is 5.5 V. Also, it is assumed that six odd-numbered bitlines BL1, BL3, BL5, BL7, BL9, and BL11 and page buffers PB1, PB3, PB5, PB7, PB9, and PB11 connected thereto are provided and threshold voltages of memory cells of a victim wordline corresponding to the page buffers PB1, PB3, PB5, PB7, PB9, and PB11 connected to the odd-numbered bitlines BL1, BL3, BL5, BL7, BL9, and BL11 are 4 V, 4.2 V, 5.1 V, 5.3 V, 5.6 V, and 5.8 V, respectively. Also, it is assumed that victim group information is stored in the third latch LT_3. Also, it is assumed that the memory cells of the page buffers PB3, PB7, and PB11 belong to the first victim group VG1 and the memory cells of the page buffers PB1, PB5, and PB9 belong to the second victim group VG2.

Referring to FIGS. 23 and 24A, first, a precharge operation may be performed.

In this case, for example, at a first time point t1, all values stored in the first latches LT_1 of the six page buffers PB1, PB3, PB5, PB7, PB9, and PB11 may be initialized to “1”.

Referring to FIGS. 23 to 24C, the sensing operation for the memory cells located in the third area “C” may be performed.

For example, as illustrated in FIGS. 23 and 24B, at a third time point t3, a value of “0” may be latched by the first latches LT_1 of the four page buffers PB5, PB7, PB9, and PB11, which correspond to memory cells whose threshold voltages are equal to or greater than 5 V, from among the page buffers PB1, PB3, PB5, PB7, PB9, and PB11.

Afterwards, for example, as illustrated in FIGS. 23 and 24C, at a fourth time point t4, a value of “1” may be latched by the first latches LT_1 of the two page buffers PB9 and PB11, which correspond to memory cells whose threshold voltages are equal to or greater than 5.5 V, from among the six page buffers PB1, PB3, PB5, PB7, PB9, and PB11.

Accordingly, information about the memory cells located in the third area “C” may be stored in the first latches LT_1 corresponding thereto.

For example, as illustrated in FIGS. 23 and 24C, at a fifth time point t5, the memory cells corresponding to the page buffers PB5 and PB7, in which a value of “0” is stored in the first latch LT_1, from among the six page buffers PB1, PB3, PB5, PB7, PB9, and PB11 may be determined as being located between the second threshold voltage (i.e., 5 V) and the third threshold voltage (i.e., 5.5 V) of the second state S2.

Meanwhile, according to some implementations, an operation of obtaining the number of memory cells located in the third area “C” may be additionally performed. For example, the number of page buffers PB5 and PB7, in which a value of “0” is stored in the first latch LT_1, from among the six page buffers PB1, PB3, PB5, PB7, PB9, and PB11 may be counted. The count value may be proportional to the number of memory cells located in the third area “C” between the second threshold voltage (i.e., 5 V) and the third threshold voltage (i.e., 5.5 V) of the second state S2. As a result, the count value of the memory cells located in the third area “C” of the second state S2 may be obtained.

Meanwhile, an operation of counting the number of memory cells located in the area between the first threshold voltage Vth1 and the second threshold voltage Vth2 of the second state S2 is similar to the operation of counting the number of memory cells located in the area between the second threshold voltage Vth2 and the third threshold voltage Vth3 of the second state S2, and thus, additional description will be omitted to avoid redundancy.

Continuing to refer to FIGS. 25 and 26, an operation of obtaining a count value of the second area “B” of the second sub-state S2_VG2 may be obtained by masking memory cells corresponding to the first sub-state S2_VG1 from among the memory cells located in the third area “C” of the second state S2.

For example, as illustrated in FIGS. 25 and 26, the memory cells corresponding to the third, seventh, and eleventh page buffers PB3, PB7, and PB11 may belong to the first victim group VG1. In this case, for example, at a sixth time point t6, values of the first latches LT_1 of the third, seventh, and eleventh page buffers PB3, PB7, and PB11 corresponding to the first victim group VG1 may be changed to “1” or may maintain “1”. For example, a value of the first latch LT_1 of the seventh page buffer PB7 may be changed from “0” to “1”. Values of the first latches LT_1 of the third and eleventh page buffers PB3 and PB11 may continuously maintain “1”.

As a result, a count value of the second area “B” of the second sub-state S2_VG2 may be obtained by masking memory cells corresponding to the first sub-state S2_VG1 being the first victim group VG1 from among the memory cells located in the third area “C” of the second state S2.

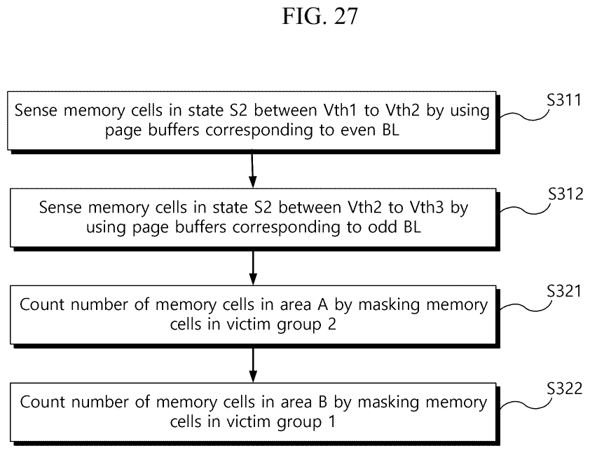

FIG. 27 is an example flowchart for performing a cell count operation for a first area of a first victim group and a cell count operation for a second area of a second victim group. For convenience of description, as in the above description given with reference to FIGS. 22 to 25, it is assumed that the cell count operation for the first area “A” of the first sub-state S2_VG1 belonging to the first victim group VG1 and the cell count operation for the second area “B” of the second sub-state S2_VG2 belonging to the second victim group VG2 are performed.

Referring to FIG. 27, in operation S311, the sensing operation for memory cells located in the area between the first threshold voltage Vth1 and the second threshold voltage Vth2 from among the memory cells of the second state S2 may be performed by using page buffers corresponding to even-numbered bitlines.

In operation S312, the sensing operation for the memory cells located in the area between the first threshold voltage Vth1 and the second threshold voltage Vth2 from among the memory cells of the second state S2 may be performed by using page buffers corresponding to odd-numbered bitlines.

In operation S321, among the memory cells located in the area between the first threshold voltage Vth1 and the second threshold voltage Vth2 of the second state S2, memory cells of the second sub-state S2_VG2 belonging to the second victim group VG2 may be masked. According to the above description, a count value of the memory cells corresponding to the first area “A” of the first sub-state S2_VG1 may be obtained.

In operation S322, among the memory cells located in the area between the second threshold voltage Vth2 and the third threshold voltage Vth3 of the second state S2, memory cells of the first sub-state S2_VG1 belonging to the first victim group VG1 may be masked. According to the above description, a count value of the memory cells corresponding to the second area “B” of the second sub-state S2_VG2 may be obtained.

Accordingly, by using only two page buffers per page buffer, the count value of the memory cells corresponding to the first area “A” of the first victim group VG1 and the count value of the memory cells corresponding to the second area “B” of the second victim group VG2 may be respectively obtained.

### Method of Counting One Area of each of at least Two Victim Groups using Different Latches

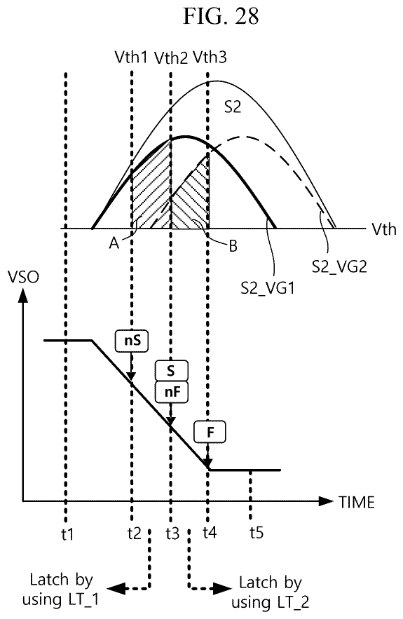

FIG. 28 is a diagram illustrating an example of a cell count operation for the first area “A” of the first victim group VG1 and the second area “B” of the second victim group VG2. An example in which a first latch of each page buffer is used for the cell count operation for the first area “A” and a second latch of each page buffer is used for the cell count operation for the second area “B” is illustrated in FIG. 28.

An operation method of FIG. 28 is similar to the operation method of FIGS. 21 to 27, and thus, additional description will be omitted to avoid redundancy.

Referring to FIG. 28, first, a precharge operation may be performed.

For example, at a first time point t1, all values stored in latches of page buffers connected to bitlines may be initialized. For example, a value stored in the first latch LT_1 (refer to FIG. 21) of each page buffer may be initialized to “1”.

Afterwards, a first sensing operation may be performed.

For example, at a second time point t2, a value stored in the first latch LT_1 (refer to FIG. 21) of a page buffer, which corresponds to a memory cell whose threshold voltage is equal to or greater than the first threshold voltage Vth1, from among page buffers may be changed from “1” to “0”. Afterwards, at a third time point t3, a value stored in the first latch LT_1 of a page buffer, which corresponds to a memory cell whose threshold voltage is equal to or greater than the second threshold voltage Vth2, from among the page buffers may be changed from “0” to “1 According to the above description, information about memory cells located in an area between the first threshold voltage Vth1 and the second threshold voltage Vth2 of the second state S2 may be stored in the corresponding first latches.

Meanwhile, a second sensing operation may be performed by changing a develop time to be different from that of the first sensing operation.

For example, at a third time point t3, a value stored in the second latch LT_2 (refer to FIG. 21) of a page buffer, which corresponds to a memory cell whose threshold voltage is equal to or greater than the second threshold voltage Vth2, from among the page buffers may be changed from “1” to “0”. Afterwards, at a fourth time point t4, a value stored in the second latch LT_2 of a page buffer, which corresponds to a memory cell whose threshold voltage is equal to or greater than the third threshold voltage Vth3, from among the page buffers may be changed from “0” to “1”. According to the above description, information about memory cells located in an area between the second threshold voltage Vth2 and the third threshold voltage Vth3 of the second state S2 may be stored in the corresponding second latches.

Afterwards, at a fifth time point t5, memory cells belonging to the second sub-state S2_VG2 of the second victim group VG2 from among the memory cells located in the area between the first threshold voltage Vth1 and the second threshold voltage Vth2 of the second state S2 may be masked. According to the above description, a count value indicating the number of memory cells corresponding to the first area “A” of the first sub-state S2_VG1 may be obtained.

Also, afterwards, memory cells belonging to the first sub-state S2_VG1 from among the memory cells located in the area between the second threshold voltage Vth2 and the third threshold voltage Vth3 of the second state S2 may be masked. According to the above description, a count value indicating the number of memory cells corresponding to the second area “B” of the second sub-state S2_VG2 may be obtained.

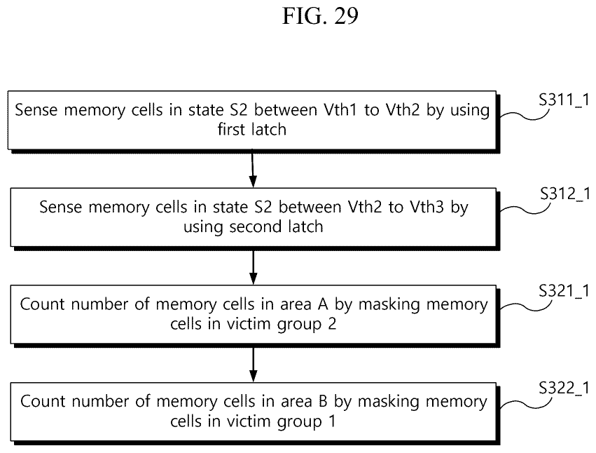

FIG. 29 is an example flowchart for performing a cell count operation for a first area of a first victim group and a cell count operation for a second area of a second victim group. For convenience of description, as in the above description given with reference to FIG. 27, it is assumed that the cell count operation for the first area “A” of the first victim group VG1 belonging to the first victim group VG1 and the cell count operation for the second area “B” of the second sub-state S2_VG2 belonging to the second victim group VG2 are performed.

In operation S311_1, the sensing operation for memory cells located in an area between the first threshold voltage Vth1 and the second threshold voltage Vth2 from among memory cells of the second state S2 may be performed by using first latches of page buffers.

In operation S312_1, the sensing operation for the memory cells located in the area between the first threshold voltage Vth1 and the second threshold voltage Vth2 of the second state S2 may be performed by using second latches of the page buffers.

In operation S321_1, among the memory cells located in the area between the first threshold voltage Vth1 and the second threshold voltage Vth2 of the second state S2, memory cells of the second sub-state S2_VG2 belonging to the second victim group VG2 may be masked. According to the above description, a count value of the memory cells corresponding to the first area “A” of the first sub-state S2_VG1 may be obtained.

In operation S322_1, among the memory cells located in the area between the second threshold voltage Vth2 and the third threshold voltage Vth3 of the second state S2, memory cells of the first sub-state S2_VG1 belonging to the first victim group VG1 may be masked. According to the above description, a count value of the memory cells corresponding to the second area “B” of the second sub-state S2_VG2 may be obtained.

Accordingly, by using only the first latches and the second latches of the page buffers, the count value of the memory cells corresponding to the first area “A” of the first victim group VG1 and the count value of the memory cells corresponding to the second area “B” of the second victim group VG2 may be respectively obtained.

Meanwhile, in FIGS. 22 to 29, the description is given as the first sensing operation and the second sensing operation are performed by changing the develop time in a state where the same read voltage is used. However, this is provided as an example, and the present disclosure is not limited thereto. For example, as will be described below, a count operation for memory cells corresponding to a first area of a first victim group and a count operation for memory cells corresponding to a second area of a second victim group may be performed independently.

### Method of Counting One Area of each of at Least Two Victim Groups Independently

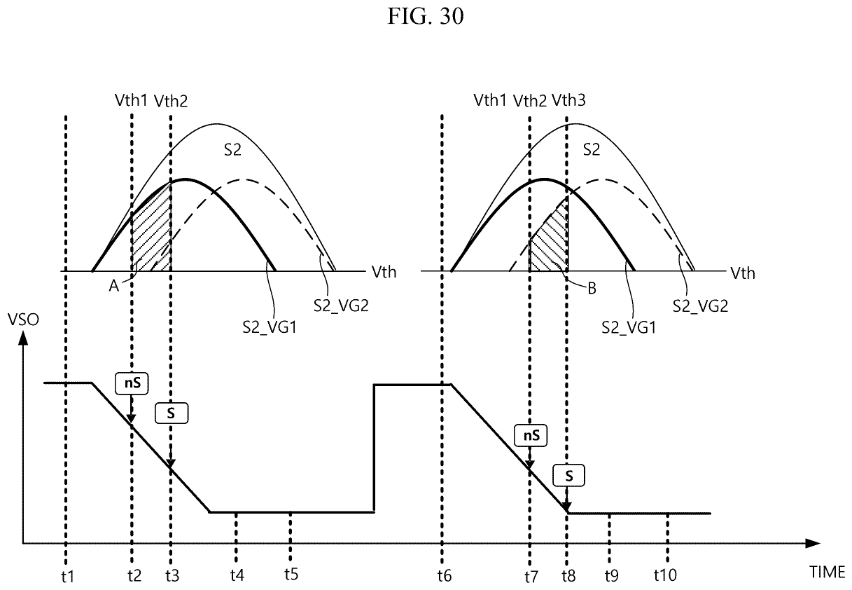

FIG. 30 is a diagram illustrating an example of a cell count operation for the first area “A” of the first victim group VG1 and the second area “B” of the second victim group VG2. An example in which the cell count operation for the first area “A” and the cell count operation for the second area “B” are performed independently of each other is illustrated in FIG. 30.

An operation method of FIG. 30 is similar to the operation method of FIGS. 21 to 26 and 28, and thus, additional description will be omitted to avoid redundancy.

Referring to FIG. 28, first, a first precharge operation may be performed.

For example, at a first time point t1, all values stored in latches of page buffers connected to bitlines may be initialized. For example, a value stored in the first latch LT_1 (refer to FIG. 21) of each page buffer may be initialized to “1”.

Afterwards, a first sensing operation may be performed.

For example, at a second time point t2, a value stored in the first latch LT_1 (refer to FIG. 21) of a page buffer, which corresponds to a memory cell whose threshold voltage is equal to or greater than the first threshold voltage Vth1, from among page buffers may be changed from “1” to “0”. Afterwards, at a third time point t3, a value stored in the first latch LT_1 of a page buffer, which corresponds to a memory cell whose threshold voltage is equal to or greater than the second threshold voltage Vth2, from among the page buffers may be changed from “0” to “1 According to the above description, information about memory cells located in an area between the first threshold voltage Vth1 and the second threshold voltage Vth2 of the second state S2 may be stored in the corresponding first latches.

Afterwards, a first masking operation may be performed.

For example, at a fifth time point t5, memory cells belonging to the second sub-state S2_VG2 of the second victim group VG2 from among the memory cells located in the area between the first threshold voltage Vth1 and the second threshold voltage Vth2 of the second state S2 may be masked. According to the above description, a count value indicating the number of memory cells corresponding to the first area “A” of the first sub-state S2_VG1 may be obtained.

Afterwards, a second precharge operation may be performed.

For example, at a sixth time point t6, all values stored in the latches of the page buffers connected to bitlines may be initialized. For example, a value stored in the first latch LT_1 of each page buffer may be initialized to “1”.

Afterwards, a second sensing operation may be performed.

For example, at a seventh time point t7, a value stored in the first latch LT_1 of a page buffer, which corresponds to a memory cell whose threshold voltage is equal to or greater than the second threshold voltage Vth2, from among the page buffers may be changed from “1” to “0”. Afterwards, at an eighth time point t8, a value stored in the first latch LT_1 of a page buffer, which corresponds to a memory cell whose threshold voltage is equal to or greater than the third threshold voltage Vth3, from among the page buffers may be changed from “0” to “1”. According to the above description, information about memory cells located in an area between the second threshold voltage Vth2 and the third threshold voltage Vth3 of the second state S2 may be stored in the corresponding first latches.

Afterwards, a second masking operation may be performed.

For example, at a tenth time point t10, memory cells belonging to the first sub-state S2_VG1 of the first victim group VG1 from among the memory cells located in the area between the second threshold voltage Vth2 and the third threshold voltage Vth3 of the second state S2 may be masked. According to the above description, a count value indicating the number of memory cells corresponding to the second area “B” of the second sub-state S2_VG2 may be obtained.

### Memory Device Setting Read Voltage Level for Data Recovery Read Operation Based on Count Value of Victim Group

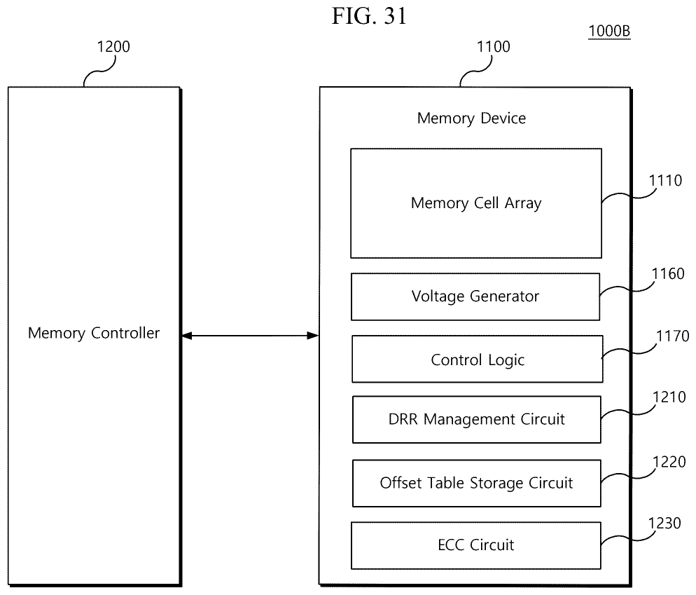

FIG. 31 is a block diagram illustrating an example of a data storage device 1000B.

The data storage device 1000B of FIG. 31 is similar to the data storage device 1000A of FIGS. 1 to 30, and thus, additional description will be omitted to avoid redundancy.

Referring to FIG. 31, the data storage device 1000B may include the memory device 1100 and the memory controller 1200. The memory device 1100 may include the memory cell array 1110, the voltage generator 1160, the control logic 1170, the DRR management circuit 1210, the offset table storage circuit 1220, and the ECC circuit 1230.

In FIGS. 1 to 30, the description is given as the DRR management circuit 1210 and the ECC circuit 1230 are included in the memory controller 1200. However, this is provided as an example, and the present disclosure is not limited thereto. For example, as illustrated in FIG. 31, the DRR management circuit 1210 and/or the ECC circuit 1230 may be implemented to be included in the memory device 1100. In this case, according to some implementations, the DRR management circuit 1210 and/or the ECC circuit 1230 may be implemented with one circuit together with the control logic 1170.

A semiconductor memory device may perform an optimal data recovery read operation even in various deterioration situations.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been described with reference to implementations thereof, it will be apparent to those of ordinary skill in the art that various changes and modifications may be made thereto without departing from the spirit and scope of the present disclosure as set forth in the following claims.

What is claimed is:

1. A data recovery operation method comprising:
classifying, based on information of an aggressor wordline adjacent to a victim wordline among a plurality of wordlines, a first plurality of memory cells into a plurality of victim groups, the first plurality of memory cells being connected with the victim wordline;
performing a first cell count operation for a first area of a first victim group among the plurality of victim groups and performing a second cell count operation for a second area of a second victim group among the plurality of victim groups, respectively;
determining, based on a first count value of the first area and a second count value of the second area, a data recovery read voltage level; and
performing, based on the data recovery read voltage level, a data recovery read operation for the victim wordline.

2. The data recovery operation method of claim 1, wherein classifying the first plurality of memory cells into the plurality of victim groups includes:
performing a read operation for the aggressor wordline;
classifying, based on a result of the read operation for the aggressor wordline, a second plurality of memory cells into a plurality of aggressor groups, the second plurality of memory cells being connected with the aggressor wordline; and
classifying, based on aggressor group information about each memory cell of the second plurality of memory cells, the first plurality of memory cells into the plurality of victim groups.

3. The data recovery operation method of claim 2, wherein each memory cell of the first plurality of memory cells corresponds to one of a plurality of states based on a threshold voltage, and
wherein each state of the plurality of states is divided, based on victim group information about the first plurality of memory cells, into a first sub-state belonging to the first victim group and a second sub-state belonging to the second victim group.

4. The data recovery operation method of claim 3, wherein performing the first cell count operation and the second cell count operation includes:
obtaining the first count value indicating a number of memory cells corresponding to the first area of the first sub-state belonging to the first victim group; and
obtaining the second count value indicating a number of memory cells corresponding to the second area of the second sub-state belonging to the second victim group.

5. The data recovery operation method of claim 4, wherein obtaining the first count value includes:
sensing, based on a first plurality of page buffers corresponding to a plurality of even-numbered bitlines among a plurality of bitlines, a plurality of memory cells corresponding to an area between a first threshold voltage and a second threshold voltage of a selected state of the plurality of states; and
performing a first masking operation for a plurality of memory cells of the second sub-state belonging to the second victim group to obtain the first count value corresponding to the first area.

6. The data recovery operation method of claim 5, wherein obtaining the second count value includes:
sensing, based on a second plurality of page buffers corresponding to a plurality of odd-numbered bitlines among the plurality of bitlines, a plurality of memory cells corresponding to an area between the second threshold voltage and a third threshold voltage of the selected state; and
performing a second masking operation for a plurality of memory cells of the first sub-state belonging to the first victim group to obtain the second count value corresponding to the second area.

7. The data recovery operation method of claim 4, wherein obtaining the first count value includes:
sensing, based on a first plurality of latches of a plurality of page buffers, a plurality of memory cells corresponding to an area between a first threshold voltage and a second threshold voltage of a selected state of the plurality of states; and
performing a first masking operation for a plurality of memory cells of the second sub-state belonging to the second victim group to obtain the first count value corresponding to the first area, and
wherein obtaining the second count value includes:
sensing, based on a second plurality of latches of the plurality of page buffers, a plurality of memory cells corresponding to an area between the second threshold voltage and a third threshold voltage of the selected state; and
performing a second masking operation for a plurality of memory cells of the first sub-state belonging to the first victim group to obtain the second count value corresponding to the second area.

8. The data recovery operation method of claim 7, wherein obtaining the first count value includes a first precharge operation, and wherein obtaining the second count value includes a second precharge operation.

9. The data recovery operation method of claim 1, wherein determining the data recovery read voltage level includes:
checking, based on a comparison result of the first count value and the second count value, a deterioration type of the first plurality of memory cells; and
determining, based on the deterioration type, the data recovery read voltage level.

10. The data recovery operation method of claim 9, wherein, based on a difference between the first count value and the second count value being smaller than a reference value, the deterioration type has a first lateral spreading, and
wherein, based on the difference between the first count value and the second count value being greater than the reference value, the deterioration type has a second lateral spreading smaller than the first lateral spreading.

11. The data recovery operation method of claim 9, wherein determining, based on the deterioration type, the data recovery read voltage level includes:
selecting, based on the deterioration type, an offset table among a plurality of offset tables;
selecting, based on a sum of the first count value and the second count value, an offset voltage in the selected offset table; and
determining, based on the selected offset voltage, the data recovery read voltage level.

12. The data recovery operation method of claim 11, wherein, based on a difference between the first count value and the second count value being smaller than a reference value, a first offset table including a first offset voltage among the plurality of offset tables is selected, and
wherein, based on the difference between the first count value and the second count value being greater than the reference value, a second offset table including a second offset voltage among the plurality of offset tables is selected, the second offset voltage being smaller than the first offset voltage.

13. The data recovery operation method of claim 9, wherein determining, based on the deterioration type, the data recovery read voltage level includes:
applying a common offset table among a plurality of offset tables;
selecting, based on a sum of the first count value and the second count value, an offset voltage in the offset table;
compensating, based on the deterioration type, the offset voltage and setting the compensated offset voltage to a voltage with magnitude different from the offset voltage; and
determining, based on the compensated offset voltage, the data recovery read voltage level.

14. The data recovery operation method of claim 13, wherein, based on a difference between the first count value and the second count value being smaller than a reference value, the offset voltage is compensated using a first voltage, and
wherein, based on the difference between the first count value and the second count value being greater than the reference value, the offset voltage is compensated using a second voltage smaller than the first voltage.

15. A data storage device comprising:
a memory device including a plurality of memory cells connected with a plurality of wordlines; and
a memory controller configured to control the memory device,
wherein, in a data recovery read operation, the memory controller is configured to determine, based on a first count value of a first area of a first victim group and a second count value of a second area of a second victim group, a read voltage level for the data recovery read operation, the first victim group and the second victim group corresponding to a victim wordline among the plurality of wordlines.

16. The data storage device of claim 15, wherein the memory controller is configured to:
classify, based on information of an aggressor wordline adjacent to the victim wordline, a first plurality of memory cells into a plurality of victim groups, the first plurality of memory cells being connected with the victim wordline;
obtain the first count value through a first cell count operation for the first area of the first victim group among the plurality of victim groups; and
obtain the second count value through a second cell count operation for the second area of the second victim group among the plurality of victim groups.

17. The data storage device of claim 15, wherein the memory controller includes a first offset table storing a first offset voltage and a second offset table storing a second offset voltage smaller than the first offset voltage,
wherein, based on a difference between the first count value and the second count value being smaller than a reference value, the memory controller is configured to determine, using the first offset table, the read voltage level for the data recovery read operation, and
wherein, based on the difference between the first count value and the second count value being greater than the reference value, the memory controller is configured to determine, using the second offset table, the read voltage level for the data recovery read operation.

18. The data storage device of claim 17, wherein, based on the difference between the first count value and the second count value being smaller than the reference value, the memory controller is configured to select, based on a sum of the first count value and the second count value, a first offset voltage to be used in the data recovery read operation from the first offset table, and
wherein, based on the difference between the first count value and the second count value being greater than the reference value, the memory controller is configured to select, based on the sum of the first count value and the second count value, a second offset voltage to be used in the data recovery read operation from the second offset table.

19. The data storage device of claim 15, wherein the memory controller includes an offset table storing an offset voltage,
wherein, based on a difference between the first count value and the second count value being smaller than a reference value, the memory controller is configured to compensate, using a first voltage level, the offset voltage of the offset table, and
wherein, based on the difference between the first count value and the second count value being greater than the reference value, the memory controller is configured to compensate, using a second voltage level smaller than the first voltage level, the offset voltage of the offset table.

20. A memory device comprising:
a memory cell array including a plurality of memory cells connected with a plurality of wordlines;
a data recovery read management circuit configured to determine, based on a first count value of a first area of a first victim group and a second count value of a second area of a second victim group, a voltage level for a data recovery read operation, the first victim group and the second victim group corresponding to a victim wordline among the plurality of wordlines; and
a voltage generator configured to generate a voltage to be used in the data recovery read operation.
